(19) United States
(12) Patent Application Publication
(10) Pub. No.: US 2014/0067354 A1
(43) Pub. Date: Mar. 6, 2014

(54) Method and System of Suggesting Spinal Cord Stimulation Region Based on Pain and Stimulation Maps with a Clinician Programmer

(71) Applicant: Greatbatch Ltd., Clarence, NY (US)

(72) Inventors: Norbert Kaula, Arvada, CO (US); Yohannes Iyassu, Denver, CO (US)

(21) Appl. No.: 13/973,268

(22) Filed: Aug. 22, 2013

Related U.S. Application Data
(60) Provisional application No. 61/695,425, filed on Aug. 31, 2012.
(60) Provisional application No. 61/695,407, filed on Aug. 31, 2012.
(60) Provisional application No. 61/695,721, filed on Aug. 31, 2012.
(60) Provisional application No. 61/695,676, filed on Aug. 31, 2012.
(60) Provisional application No. 61/824,296, filed on May 16, 2013.

(51) Int. Cl. G06F 19/00

(52) U.S. Cl. CPC G06F 19/3437
USPC 703/11

(57) ABSTRACT

The present disclosure involves a method of determining stimulation lead placements for a healthcare professional with respect to an implant of a neurostimulator device in a target patient. A human body model is provided. A pain map is generated over the human body model in response to user input. The pain map visually represents body regions of the target patient that are experiencing pain. A dermatome map is provided. The dermatome map includes a visual correlation between regions of a human body and segments of a spinal cord. The pain map is compared with the dermatome map. Recommendations regarding the implant of the neurostimulator device are displayed in response to the comparing.

### PRIORITY DATA

The present application is a utility application of provisional U.S. Patent Application No. 61/695,425, filed on Aug. 31, 2012, entitled “Method and System of Suggesting Spinal Cord Stimulation Region Based on Pain and Stimulation Maps with a Clinician Programmer,” and a utility application of provisional U.S. Patent Application No. 61/695,407, filed on Aug. 31, 2012, entitled “Method and System of Producing 2D Representations of 3D Pain and Stimulation Maps and Implant Models on a Clinician Programmer,” and a utility application of provisional U.S. Patent Application No. 61/695,721, filed on Aug. 31, 2012, entitled “Method and System of Creating, Displaying, and Comparing Pain and Stimulation Maps,” and a utility application of provisional U.S. Patent Application No. 61/695,676, filed on Aug. 31, 2012, entitled “Method and System of Adjusting 3D Models of Patients on a Clinician Programmer,” and a utility application of provisional U.S. Patent Application No. 61/824,296, filed on May 16, 2013, entitled “Features and Functionalities of an Advanced Clinician Programmer,” the disclosure of which is hereby incorporated by reference in its entirety.

### BACKGROUND

As medical device technologies continue to evolve, active implanted medical devices have gained increasing popularity in the medical field. For example, one type of implanted medical device includes neurostimulator devices, which are battery-powered or battery-less devices that are designed to deliver electrical stimulation to a patient. Through proper electrical stimulation, the neurostimulator devices can provide pain relief for patients or restore bodily functions.

Implanted medical devices (for example a neurostimulator) can be controlled using an electronic programming device such as a clinician programmer or a patient programmer. These programmers can be used by medical personnel or the patient to define the particular electrical stimulation therapy to be delivered to a target area of the patient's body, alter one or more parameters of the electrical stimulation therapy, or otherwise conduct communications with a patient. Advances in the medical device field have improved these electronic programmers. For example, some existing electronic programmers allow pain maps (a depiction of the location of a patient's pain) to be displayed on a programmer. The pain maps are helpful tools in helping a healthcare professional determine an implant site and/or stimulation parameters for the implanted medical device. However, existing electronic programmers are not advanced enough to automatically recommend a target implant site (or stimulation parameters) to the healthcare professional. Existing electronic programmers are also not capable of providing a customized pain/stimulation analysis for each individual patient. Consequently, even experienced healthcare professionals have to spend a great deal of time exploring the implant site and/or stimulation parameters that are suitable for the target patient.

Therefore, although existing electronic programmers have been generally adequate for their intended purposes, they have not been entirely satisfactory in every aspect.

### SUMMARY

One aspect of the present disclosure involves a system for determining stimulation lead placements for a healthcare professional with respect to an implant of a neurostimulator device in a target patient. The electronic device includes: a memory storage component configured to store programming code; and a computer processor configured to execute the programming code to perform the following tasks: providing a human body model; generating, in response to user input, a pain map over the human body model, wherein the pain map visually represents body regions of the target patient that are experiencing pain; providing a dermatome map, wherein the dermatome map includes a visual correlation between regions of a human body and segments of a spinal cord; comparing the pain map with the dermatome map; and displaying recommendations regarding the implant of the neurostimulator device in response to the comparing.

Another aspect of the present disclosure involves a method of determining stimulation lead placements for a healthcare professional with respect to an implant of a neurostimulator device in a target patient, the method comprising: providing a human body model; generating, in response to user input, a pain map over the human body model, wherein the pain map visually represents body regions of the target patient that are experiencing pain; providing a dermatome map, wherein the dermatome map includes a visual correlation between regions of a human body and segments of a spinal cord; comparing the pain map with the dermatome map; and displaying recommendations regarding the implant of the neurostimulator device in response to the comparing.

Yet another aspect of the present disclosure involves a system of providing a recommended dermatome map for a healthcare professional to facilitate an implant of a neurostimulator device in a target patient. The system includes: an electronic server having a non-transitory computer readable medium comprising executable instructions that when executed by a processor, causes the processor to perform the steps of: receiving a plurality of dermatome maps that are each customized to a different patient, wherein each dermatome map includes a visual correlation between regions of a human body and segments of a spinal cord, and wherein each dermatome is associated with a set of patient physiological characteristics but is devoid of patient biographical identification information; establishing, on the electronic server, a dermatome map database based on the plurality of received dermatome maps; identifying a recommended dermatome map in response to a user request; and sending the recommended dermatome map to a remote electronic device of the user.

One more aspect of the present disclosure involves a method of providing a recommended dermatome map for a healthcare professional to facilitate an implant of a neurostimulator device in a target patient. The method includes: receiving a plurality of dermatome maps that are each customized to a different patient, wherein each dermatome map includes a visual correlation between regions of a human body and segments of a spinal cord, and wherein each dermatome is associated with a set of patient physiological characteristics but is devoid of patient biographical identification information; establishing a dermatome map database based on the plurality of received dermatome maps; identifying a recommended dermatome map in response to a user request; and sending the recommended dermatome map to a remote electronic device of the user.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designation have the same or similar functions.

FIG. 1 is a simplified block diagram of an example medical environment in which evaluations of a patient may be conducted according to various aspects of the present disclosure.

FIGS. 2A-2B are various views of an example dermatome map according to various aspects of the present disclosure.

FIGS. 3-4 are example sensation maps according to various aspects of the present disclosure.

FIGS. 5-7 are user interfaces for recommending implant regions and stimulation parameters according to various aspects of the present disclosure.

FIGS. 8-14 are simplified flowcharts illustrating methods of generating and using dermatome maps according to various aspects of the present disclosure.

FIG. 15 is a simplified block diagram of an electronic programmer according to various aspects of the present disclosure.

FIG. 16 is a simplified block diagram of an implantable medical device according to various aspects of the present disclosure.

FIG. 17 is a simplified block diagram of a medical system/infrastructure according to various aspects of the present disclosure.

FIGS. 18A and 18B are side and posterior views of a human spine, respectively.

### DETAILED DESCRIPTION

It is to be understood that the following disclosure provides many different embodiments, or examples, for implementing different features of the invention. Specific examples of components and arrangements are described below to simplify the present disclosure. These are, of course, merely examples and are not intended to be limiting. Various features may be arbitrarily drawn in different scales for simplicity and clarity.

The use of active implanted medical devices has become increasingly prevalent over time. Some of these implanted medical devices include neurostimulator devices that are capable of providing pain relief by delivering electrical stimulation to a patient. In that regards, electronic programmers have been used to configure or program these neurostimulators (or other types of suitable active implanted medical devices) so that they can be operated in a certain manner. These electronic programmers include clinician programmers and patient programmers, each of which may be a handheld device. For example, a clinician programmer allows a medical professional (e.g., a doctor or a nurse) to define the particular electrical stimulation therapy to be delivered to a target area of the patient's body, while a patient programmer allows a patient to alter one or more parameters of the electrical stimulation therapy.

In recent years, these electronic programmers have achieved significant improvements, for example, improvements in size, power consumption, lifetime, and ease of use. For instance, electronic programmers have been used to provide more realistic visualization of a human anatomical environment in order to achieve better diagnosis for the patient. As an example of the visualization may include computerized pain maps and stimulation maps (collectively referred to as sensation maps) for a patient. In general, a pain map shows the location or intensity of a patient's pain, and a stimulation map shows the location or intensity of the electrical stimulation (e.g., stimulation delivered by the neurostimulator) perceived by the patient. These sensation maps can serve as useful tools for diagnosing the patient's pain and also allow visual/non-verbal communication between a patient and a healthcare professional. In addition, a history of the maps, if collected, can provide a record of a patient's treatment progress, and the maps can also be analyzed across patient groups.

Electronic programmers can also be used to display dermatome maps. In general, a dermatome map refers to a visual depiction of the regions of the spinal cord that correspond to certain regions of the body. In other words, stimulation of a particular segment of the spinal cord can trigger a sensation in a certain region of the body. By the same token, a sensation such as pain in that certain region of the body may be associated with an electrical path in which the particular segment of the spinal cord belongs. In other words, the stimulation of the segment of the spinal cord and the resulting sensation felt by the patient is a two-way street. The dermatome map graphically “maps out” each segment of the spinal cord with its corresponding regions of the body. Pain maps and dermatome maps displayed on an electronic programmer can assist a healthcare professional in determining implant sites and/or stimulation parameters.

Nevertheless, conventional electronic programmers have at least the following drawbacks:
Any comparison between the pain and dermatome maps is done by the healthcare professional manually, which is time consuming and prone to errors.
The electronic programmer is unable to automatically recommend an implant site or stimulation parameters to the healthcare professional. Instead, the healthcare professional has to rely on his/her own expertise, which varies from professional to professional, thereby diminishing the reliability of the procedure.
The dermatome map is not customized for the target patient, which reduces its accuracy and effectiveness.
Currently, it is not possible to correlate pain areas or stimulation areas with spine levels.

To overcome these problems discussed above, the present disclosure offers a method and system of automatically suggesting a spinal cord stimulation region based on a comparison between a pain map and a customizable dermatome map. In various embodiments, the comparison of the pain and dermatome maps as well as the suggestion of the spinal cord stimulation region can be automatically performed by an electronic programmer, as discussed below in more detail.

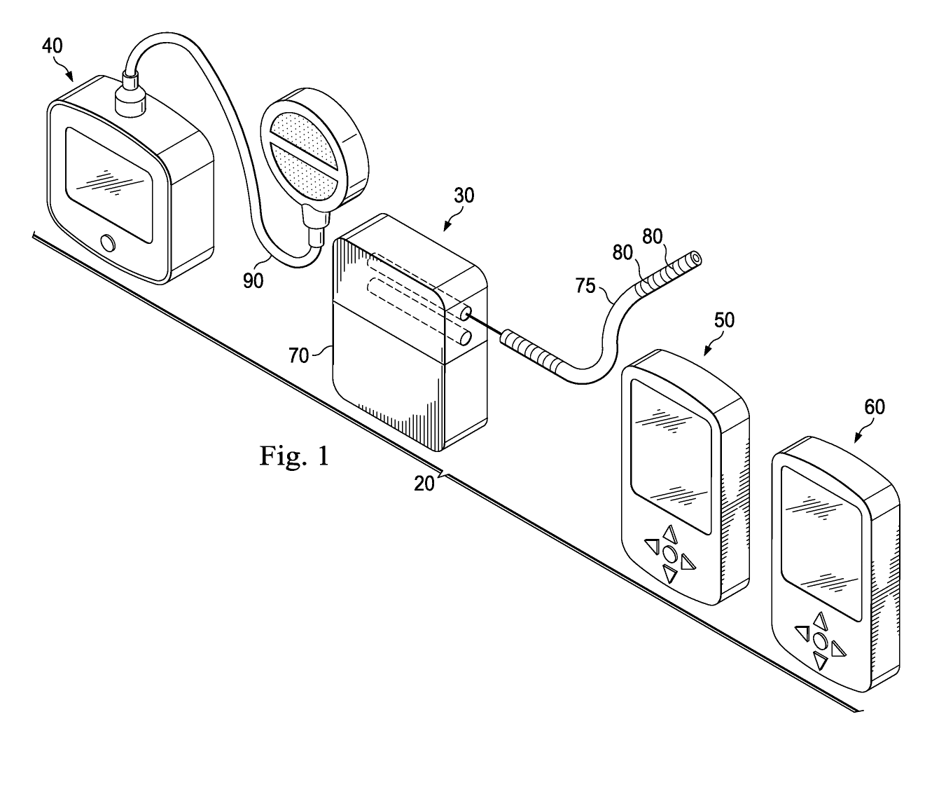

FIG. 1 is a simplified block diagram of a medical device system 20 is illustrated to provide an example context of the various aspects of the present disclosure. The medical system 20 includes an implantable medical device 30, an external charger 40, a patient programmer 50, and a clinician programmer 60. The implantable medical device 30 can be implanted in a patient's body tissue. In the illustrated embodiment, the implantable medical device 30 includes an implanted pulse generator (IPG) 70 that is coupled to one end of an implanted lead 75. The other end of the implanted lead 75 includes multiple electrode surfaces 80 through which electrical current is applied to a desired part of a body tissue of a patient. The implanted lead 75 incorporates electrical conductors to provide a path for that current to travel to the body tissue from the IPG 70. Although only one implanted lead 75 is shown in FIG. 1, it is understood that a plurality of implanted leads may be attached to the IPG 70.

Although an IPG is used here as an example, it is understood that the various aspects of the present disclosure apply to an external pulse generator (EPG) as well. An EPG is intended to be worn externally to the patient's body. The EPG connects to one end (referred to as a connection end) of one or more percutaneous, or skin-penetrating, leads. The other end (referred to as a stimulating end) of the percutaneous lead is implanted within the body and incorporates multiple electrode surfaces analogous in function and use to those of an implanted lead.

The external charger 40 of the medical device system 20 provides electrical power to the IPG 70. The electrical power may be delivered through a charging coil 90. In some embodiments, the charging coil can also be an internal component of the external charger 40. The IPG 70 may also incorporate power-storage components such as a battery or capacitor so that it may be powered independently of the external charger 40 for a period of time, for example from a day to a month, depending on the power requirements of the therapeutic electrical stimulation delivered by the IPG.

The patient programmer 50 and the clinician programmer 60 may be portable handheld devices that can be used to configure the IPG 70 so that the IPG 70 can operate in a certain way. The patient programmer 50 is used by the patient in whom the IPG 70 is implanted. The patient may adjust the parameters of the stimulation, such as by selecting a program, changing its amplitude, frequency, and other parameters, and by turning stimulation on and off. The clinician programmer 60 is used by a medical personnel to configure the other system components and to adjust stimulation parameters that the patient is not permitted to control, such as by setting up stimulation programs among which the patient may choose, selecting the active set of electrode surfaces in a given program, and by setting upper and lower limits for the patient's adjustments of amplitude, frequency, and other parameters.

In the embodiments discussed below, the clinician programmer 60 is used as an example of the electronic programmer. However, it is understood that the electronic programmer may also be the patient programmer 50 or other touch screen programming devices (such as smart-phones or tablet computers) in other embodiments.

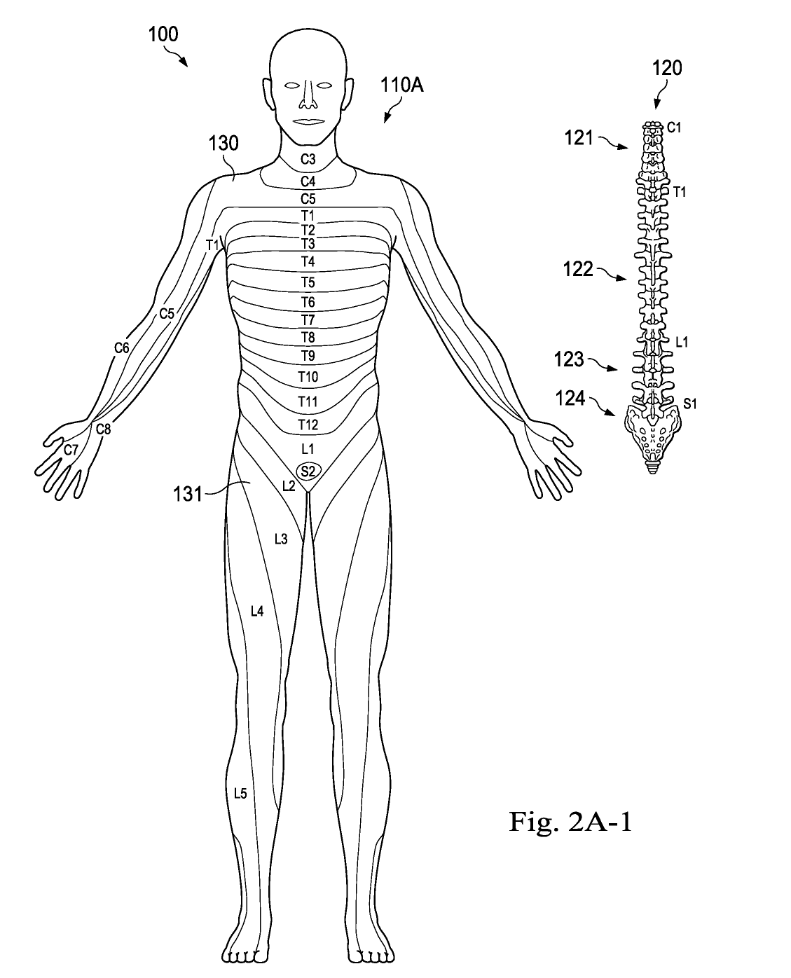

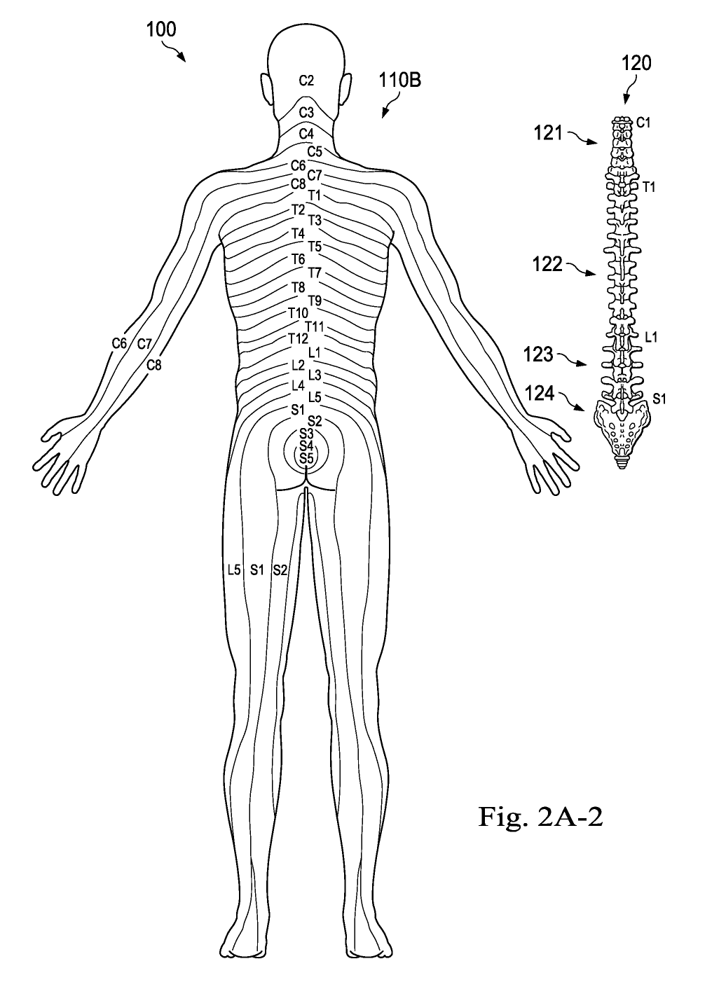

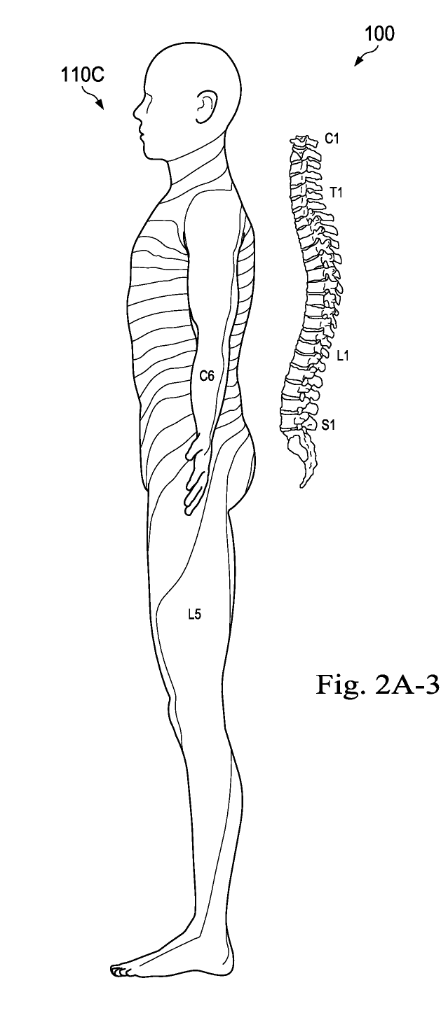

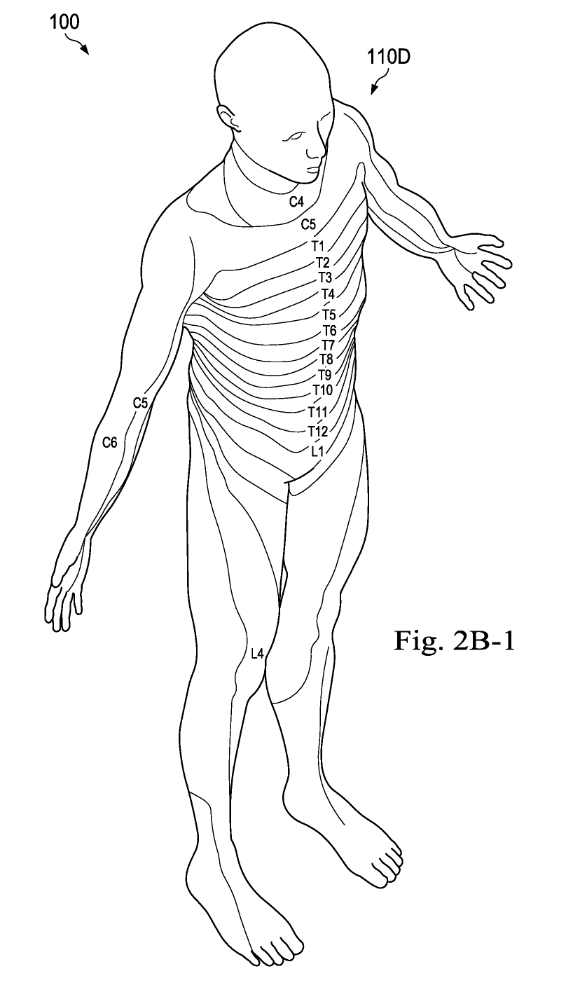

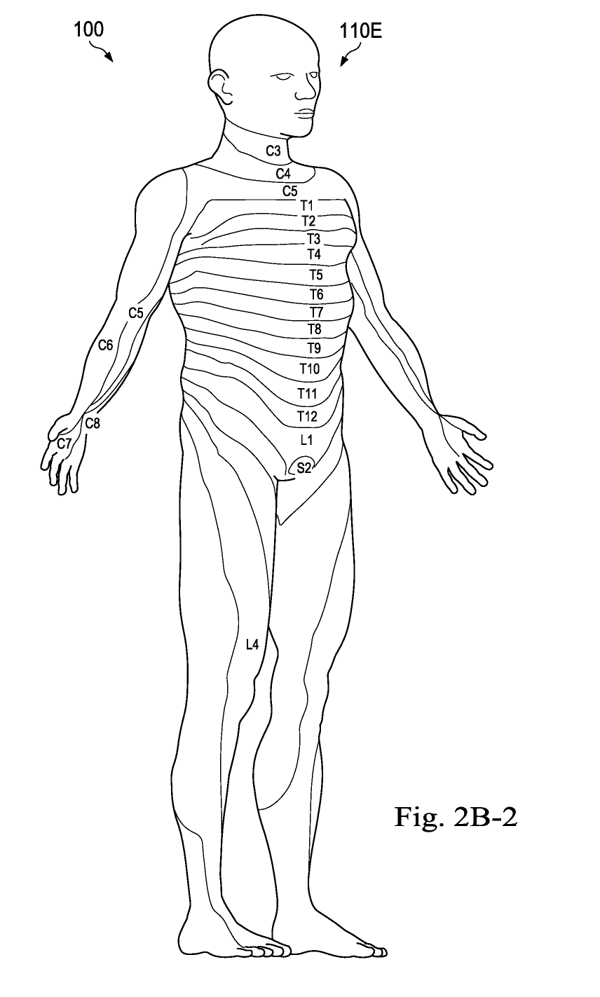

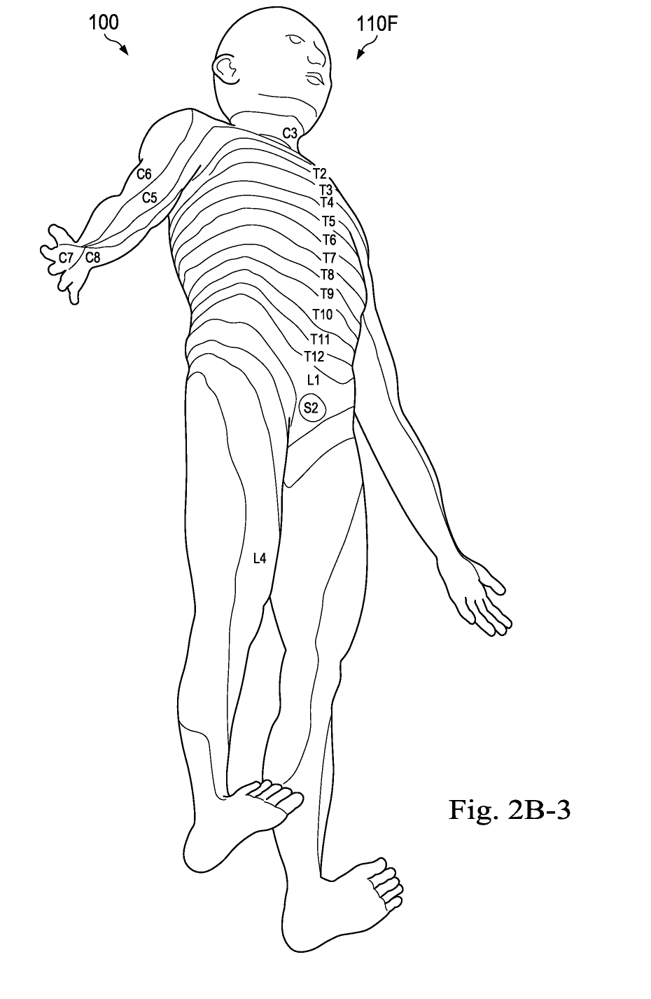

The clinician programmer 60 may be used to display a dermatome map. An example dermatome map 100 is illustrated in FIG. 2A. The dermatome map 100 includes a frontal view 110A, a back view 110B, and a side view 110C of a human body model. In the illustrated embodiments, the human body model may be three-dimensional (3D), for example as disclosed in U.S. patent application Ser. No. 13/973,219, filed Aug. 22, 2013 entitled “Method and System of Producing 2D Representations of 3D Pain and Stimulation Maps and Implant Models on a Clinician Programmer”, the disclosures of each of which are hereby incorporated by reference in their entirety. In other embodiments, the human body model may be two-dimensional (2D) as well.

In each of the views 110A-110C, the human body model is divided into a plurality of regions, where each region corresponds to a particular segment of a spinal cord. In general, a spine (e.g., spine 120 shown in FIG. 2A next to the human body model) includes a cervical region 121, a thoracic region 122, a lumbar region 123, and a sacrococcygeal region 124. The cervical region 121 includes the top 7 vertebrae, which may be designated with C1-C7. The thoracic region 122 includes the next 12 vertebrae below the cervical region 121, which may be designated with T1-T12. The lumbar region 123 includes the final 5 “true” vertebrae, which may be designated with L1-L5. The sacrococcygeal region 124 includes 9 fused vertebrae that make up the sacrum and the coccyx. The fused vertebrae of the sacrum may be designated with S1-S5.

Neural tissue (not illustrated for the sake of simplicity) branch off from the spinal cord through spaces between the vertebrae. The neural tissue can be individually and selectively stimulated by an implantable medical device such as the IPG 70 of FIG. 1. The stimulation of neural tissues in C1-C7, T1-T12, L1-L5, and S1-S5 may each be associated with a sensation in a different region of the human body model. For example, a stimulation of the neural tissue in C5 triggers a sensation in a region 130 of the body, which includes an upper portion of the chest as well as a portion of the left and right arms. As another example, a stimulation of the neural tissue in L3 triggers a sensation in a region 131 of the body, which includes a portion of the thigh as well as a portion of the calf. Thus, as the dermatome map 100 illustrates, most (if not all) of the body can be mapped to neural tissues in different segments of the spinal cord.

In some embodiments, the dermatome map 100 is a standard dermatome map, which can be downloaded or may already be preloaded into the clinician programmer 70. In other embodiments, however, a dermatome map similar to the dermatome map 100 may be customized for a target patient. There are several ways in which the dermatome map may be customized, as discussed below.

In some embodiments, the dermatome map may be customized for a specific target patient. A healthcare professional (e.g., a surgeon) may insert a lead in the patient's epidural space, which is the space within the spinal column immediately external to the outer sheath of the spinal cord. The healthcare professional then moves the lead along the entire length of the spinal cord (or a portion thereof in certain embodiments), pausing at predetermined points. Electrical stimulation is delivered through the lead as the lead is moved. The stimulation parameters may also be varied. The patient is asked to create a stimulation map (discussed in more detail below) at each spinal cord location and each new stimulation parameter. For example, using the clinician programmer 70, the patient may create a stimulation map at the C1, then another stimulation map at C2, so on and so forth, until a stimulation map is created at S5. The stimulation parameters may also be varied at each of these locations if needed. These stimulation maps corresponding to C1-C7, T1-T12, L1-L5, and S1-S5 may then be used to create a dermatome map, since the sensation in response to the stimulation of each segment of the spinal cord is visually depicted by the stimulation map. Thus, the customized dermatome map may be constructed based on the collection of these stimulation maps.

The customized dermatome map discussed above offers great accuracy, since it is customized specifically for the target patient. However, its construction may take time, and thus in situations where the healthcare professional (and/or the patient) wishes to obtain a dermatome map more quickly, a less-customized dermatome map (but still more customized than a standard dermatome map) may be generated. In more detail, dermatome maps similar to the customized dermatome map discussed above may be uploaded to a remote electronic database (also referred to as a “cloud”, which will be discussed later in greater detail). The uploading of each dermatome map is performed so that the physiological characteristics of the patient corresponding to the dermatome map are retained. The physiological characteristics may include, but are not limited to, the patient's race, ethnicity, gender, age, height, weight, body build type, or medical conditions (e.g., is the patient diabetic, or has the patient been amputated?). These physiological characteristics are retained because they may be correlated with the dermatome map. Meanwhile, the biographical identification information of the patient is removed before the dermatome map is uploaded. The biographical identification information may include the patient's name, address, employment, family status, credit score, or mental conditions. The removal of the biographical identification information may be performed in accordance with the HIPPA (Health Insurance Portability and Accountability Act) privacy rules.

Over time, the dermatome map database includes dermatome maps that come from patients with a variety of physiological characteristics. Thus, the healthcare professional for a target patient (who is ready for the implant for the neurostimulator) may query the dermatome map database for a dermatome map that is associated with a patient whose physiological characteristics have a close match to the target patient for implant. For example, the target patient may be a 40 year old Caucasian male who has a thin body build, has a height of 6′1 and a weight of 160 pounds.

Using an electronic programmer such as the clinician programmer 60, the healthcare professional may send these physiological characteristics to the dermatome map database and request that the dermatome map database provide a dermatome map whose associated patient has characteristics that match those of the target patient. The dermatome map database may review the dermatome maps, and the one with the closest matching characteristics may be a 38 year old Caucasian male with a thin body build, who has a height of 6′2 and a weight of 165 pounds. Though these characteristics are not identical with those of the target patient, the dermatome map associated therewith may be sufficiently accurate for the purposes of quickly providing a customized dermatome map. Therefore, the dermatome map database may send the identified dermatome map to the healthcare professional (for example, to the clinician programmer of the healthcare professional). The healthcare professional may then use that dermatome map for further diagnosis and analysis for the purposes of the present disclosure.

In some embodiments, the healthcare professional may select just a subset of physiological characteristics to query the dermatome database. For example, in the same patient example discussed above, the healthcare professional may decide that the patient's age and race are irrelevant (or less relevant than other physiological characteristics). Correspondingly, the healthcare professional may decide to only use the height, weight, and body build type of the patient to query the dermatome database. In that case, the dermatome map may identify a different dermatome map that the one previously identified, which could then be sent to the clinician programmer of the healthcare professional for further diagnosis and analysis. Alternatively, the dermatome map database may identify several dermatome maps in response to the query by the healthcare professional, and offer the healthcare professional the option to choose one that he deems most relevant or potentially accurate for further use. In other words, in some embodiments, the dermatome map identified by the dermatome map database may be one whose corresponding patient has at least one matching physiological characteristic with the target patient.

Since each healthcare professional may have his/her unique method of diagnosing and treating pain as well as his/her unique technique of implanting a neurostimulator, he/she may deem his/her previous patients to be more relevant for the purposes of treating the current target patient, even if the previous patients do not have the closest matching physiological characteristics compared with the target patient. Therefore, the dermatome map database may allow the healthcare professional to query the database for just the dermatome maps whose patients were ex-patients of the healthcare professional. The dermatome map database may return all the dermatome maps associated with ex-patients of the healthcare professional, or just a subset of the dermatome maps whose patients meet a defined criterion. For example, the dermatome map database may return dermatome maps whose patients were not only ex-patients of the querying healthcare professional, but also patients who are of a certain race, gender, height, weight, etc. The healthcare professional may then select one of these dermatome maps for further diagnosis and analysis.

In yet other embodiments, the dermatome map database may return a dermatome map that is not any one particular dermatome map stored in the database, but rather a dermatome map as a result of average a plurality of dermatome maps together. For example, the healthcare professional may query the dermatome map database to provide a customized dermatome map for a target patient who is a Caucasian male with a thin body build, who has a height of 6′2 and a weight of 165 pounds. In response to this request, the dermatome map database may identify all dermatome maps whose patients have closely matched physiological characteristics with the target patient. For instance, the identified dermatome maps may come from patients who are Caucasian males with a thin body build, who have heights between 6′1 and 6′3, and who have weights between 155 pounds and 175 pounds.

These dermatome maps may then be averaged together to generate a new dermatome map, which is selected as the customized dermatome map to be sent to the healthcare professional. The averaging of these dermatome maps may involve, as examples, averaging areas of experienced stimulation for each spinal cord segment. Other suitable averaging techniques may also be employed. The end result is a dermatome map that may be more free of outliers (as these outliers are averaged out), which means that it may be more representative of the target patient's “true” dermatome map. In certain embodiments, the dermatome map database may prompt the healthcare professional to enter the criteria for identifying suitable patients. For example, the healthcare professional may be prompted to enter a race, age, gender, height range, or weight range of patients whose dermatome maps should be averaged together to generate the customized dermatome map for the target patient.

It is understood that FIG. 2A is merely provides some example three-dimensional (3D) views of the dermatome map 100. FIG. 2B illustrates additional example views of the dermatome map 100 from different angles. In more detail, FIG. 2B illustrates a 45-degree view from the top 110D, a 45-degree view from the hip 100E, and a 45-degree view from the bottom 100F. Note that the views 110A-100F correspond to the same 3D dermatome map 100, but taken from different viewing angles. As a 3D object, the dermatome map 100 may be freely rotated, resized, moved, or otherwise manipulated to allow the user focus in on any specific body region.

3D modeling is also useful for many types of applications on a clinician programmer. One example use for 3D models on a clinician programmer is pain mapping or stimulation mapping (collectively referred to as sensation mapping). In general, compared to traditional 2D images, 3D sensation maps allow a healthcare professional to see a fuller and more accurate representation of the location of the patient's pain or stimulation.

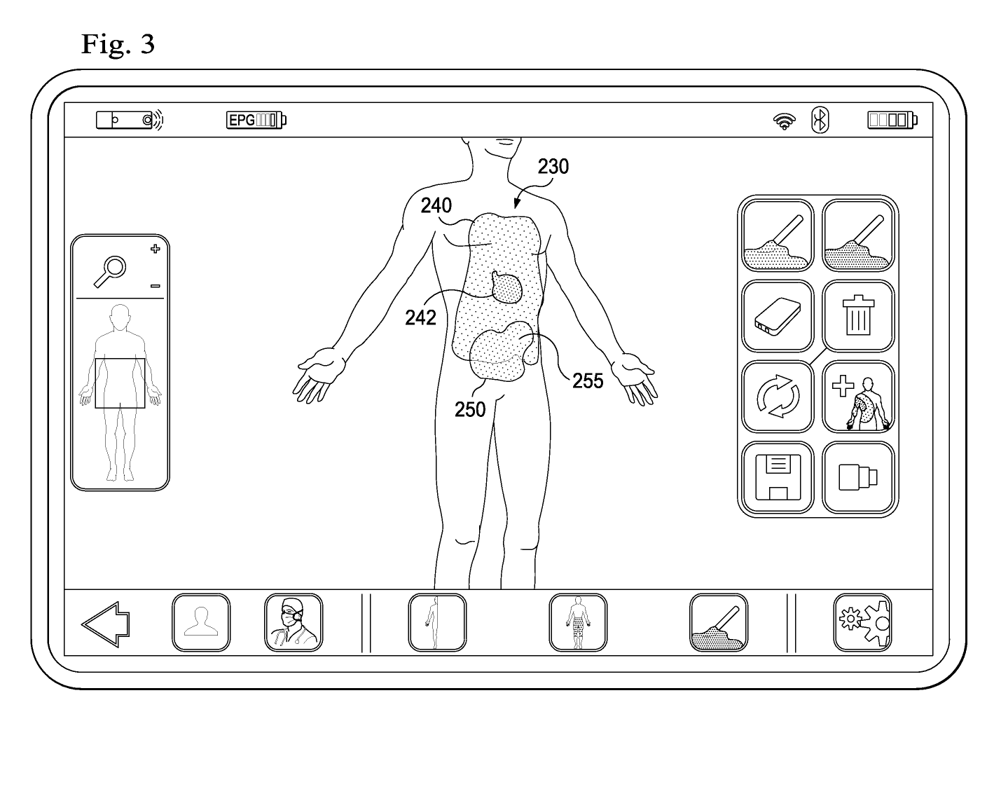

An example sensation map 230 is shown in FIG. 3, which contains an example screenshot of a user interface for generating and displaying 3D sensation maps. In some embodiments, the sensation map 230 may be displayed on a screen of a programmer, for example (but not limited to) a capacitive or resistive touch-sensitive display. In other embodiments, the user interface 100 may be displayed on a programmer and an external monitor simultaneously, for example in accordance with U.S. patent application Ser. No. 13/600,875, filed on August 31, entitled “Clinician Programming System and Method”, attorney docket 46901.11/QIG068, the disclosure of which is hereby incorporated by reference in its entirety. As such, both the healthcare professional and the patient are able to view the user interface at the same time.

The sensation map 230 is displayed on a 3D human body model in the present example. The human body model can also be moved in all directions, rotated, resized, or otherwise manipulated. In some embodiments, the human body model is customized for a specific patient. For instance, if a patient is tall (e.g., 6 feet or taller), the human body model may be created (or later resized) to be “taller” too, so as to correspond with the patient's height. As another example, if the patient is overweight or underweight, the human body model may be created (or later resized) to be wider or narrower, so as to correspond with the patient's weight. As other examples, if the patient has particularly long or short limbs, hands/feet, or a specific body build, the human body model may be created (or later resized) to correspond with these body characteristics of the patient as well.) Additional details for creating the 3D human body model are discussed in U.S. patent application Ser. No. 13/973,219, filed Aug. 22, 2013 entitled “Method and System of Producing 2D Representations of 3D Pain and Stimulation Maps and Implant Models on a Clinician Programmer”, the disclosure of which is hereby incorporated by reference in its entirety.

The sensation map 230 can be created in response to a gesture-based input from a user. For example, using a tactile-based input, a patient can use his/her finger(s) as a simulated brush to draw or paint an area on the human body model (displayed on the clinician programmer) that corresponds to a region of pain the patient experiences. If the patient feels pain in his/her shoulder, he/she can paint a pain map on the shoulder region of the human body model. The human body model can also be rotated, so that the patient can paint the pain map in different regions of the human body model. The patient may revise the pain map to correspond as closely with the actual perceived regions of pain as possible. To facilitate the painting/drawing of the pain maps, the simulated brush may be of adjustable size. The stimulation map may be created in a similar manner, except that the stimulation map corresponds with the perceived stimulation experienced by the patient.

The sensation map is drawn on a touch-sensitive screen of the clinician programmer in the illustrated embodiment, but it is understood that alternative types of input/output devices may be used to create the sensation map. In addition, other suitable gesture-based input may be used to create the sensation map, for example a gesture input that does not involve touch, but rather the motions of arms/hands/fingers, may be used. These non-touch-related gesture input may also require a camera or other types of sensors to detect the movement of the user's arms/hands/fingers in various embodiments.

The patient may also indicate the intensity of the pain or stimulation with different colors or shading. For example, the patient may draw a region 240 as a “baseline” pain region. This region 240 may represent the body regions where the patient feels some degree of pain. The patient may also draw a region 242 within the region 242 as an “intense” or “acute” pain region. In other words, the patient may feel much more pain in the region 142 than in the rest of the region 240. The degree of the pain intensity may correspond with a color (or hue) of the region, and a variety of colors may be available to represent different degrees of pain. Thus, a pain map of the present disclosure may reveal various regions with different degrees of pain. In some embodiments, the more painful regions are represented by darker colors, and the less painful regions are represented by lighter colors. The opposite may be true in other embodiments.

Similarly, the patient may also draw a region 250 over the 3D model to indicate a region on the body where the patient experiences stimulation. Note that the pain region 240 and the stimulation region 250 may be displayed simultaneously, as shown in FIG. 3. An overlapping region 255 (an overlapping between the pain region 240 and the stimulation region 250) may also be displayed, which is helpful in helping the healthcare professional in diagnosing and treating the patient. Also, although not specifically illustrated for reasons of simplicity, it is understood that the patient may also use different shading or coloring to designate different degrees of stimulation for the stimulation region 250. Again, additional details for generating the pain/stimulation maps are discussed in U.S. patent application Ser. No. 13/973,219, filed Aug. 22, 2013 entitled “Method and System of Producing 2D Representations of 3D Pain and Stimulation Maps and Implant Models on a Clinician Programmer”.

According to the various aspects of the present disclosure, the target patient who is to receive the neurostimulator implant is asked to create a pain map that represents the pain experienced by him/her. A dermatome map is also provided, which as discussed above may be customized for the patient or may be a generic one. The clinician programmer then correlates the pain map with the dermatome map and displays a recommendation regarding the implant of the neurostimulator accordingly.

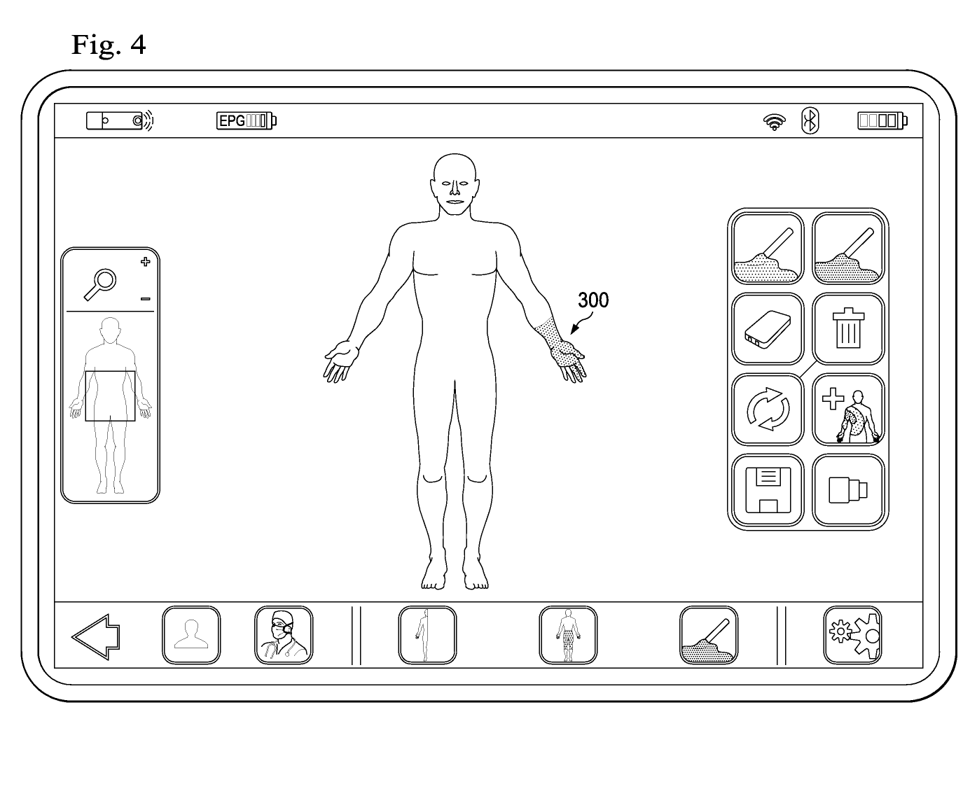

In more detail, referring now to FIG. 4, the patient creates a pain map 300, which indicates pain in the left hand and wrist of the patient. Although not specifically illustrated for reasons of simplicity, the patient may also create a stimulation map along with the pain map 300 to illustrate where the stimulation is less effective, and these regions may be specifically targeted with spinal cord stimulation. In any case, the clinician programmer correlates the pain map 300 with a dermatome map (e.g., dermatome map 100 in FIG. 2, or a 3D dermatome map), and the correlation may identify which regions of the spinal cord needs to be stimulated (along with other suitable stimulation parameters), either visually and/or textually.

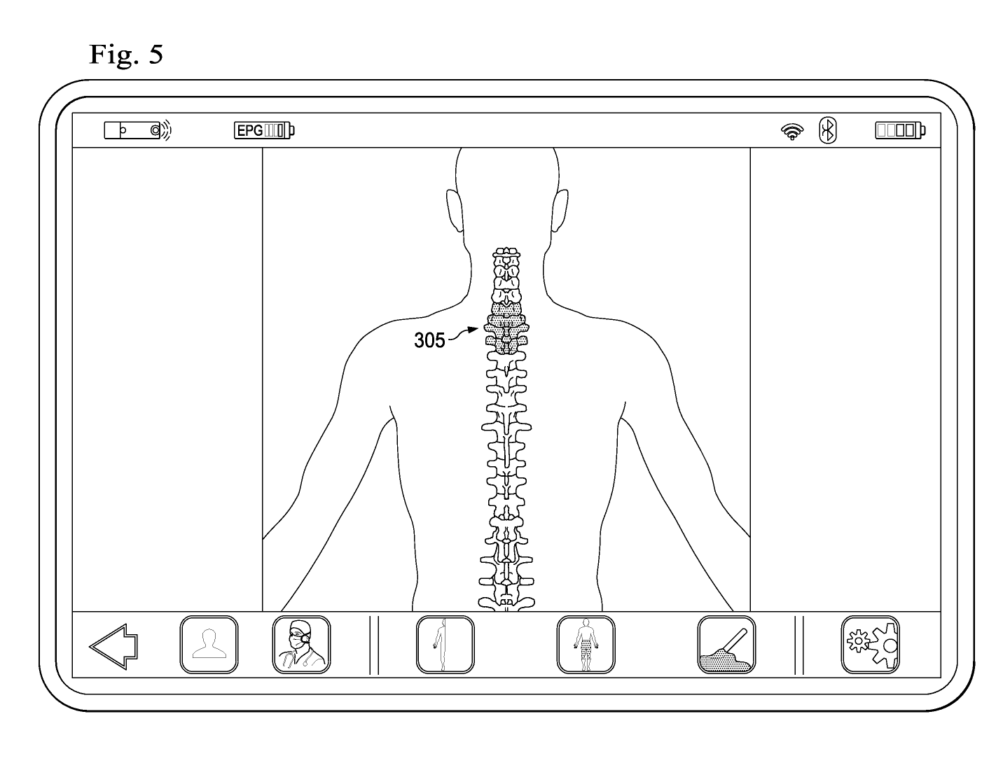

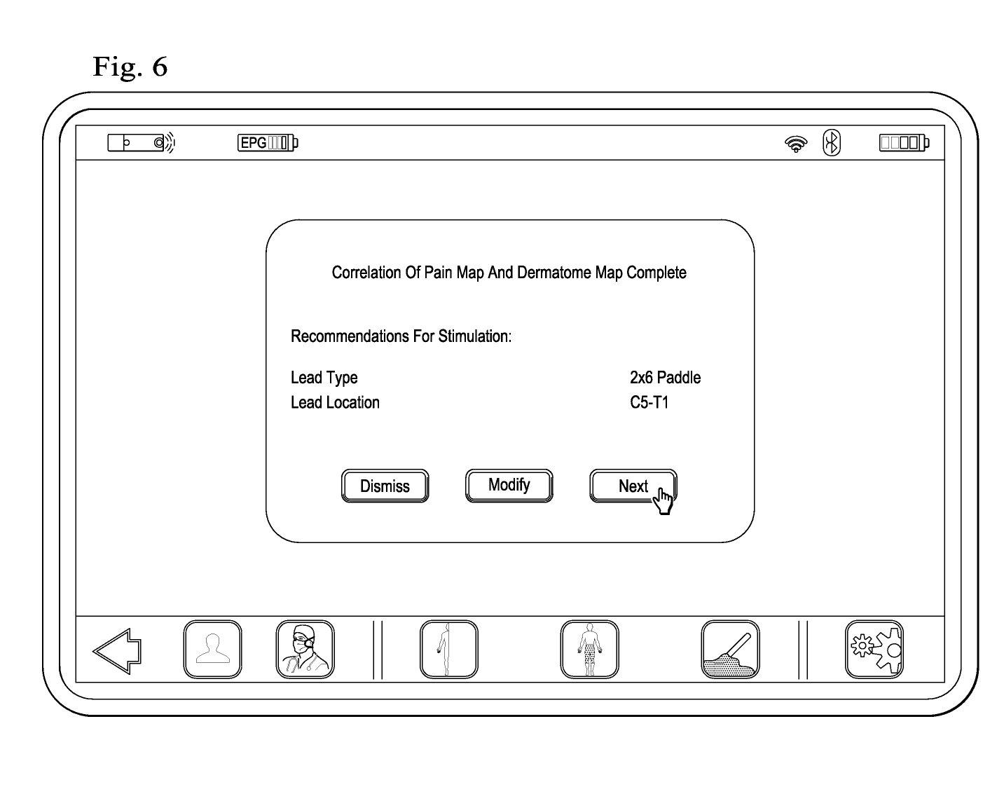

For example, FIG. 5 shows a visual location 305 of the recommended implant location based on the correlation of the dermatome map and the pain map 300. In other words, the highlighted visual location 305 represents the vertebrae corresponding to the segments of the spinal cord needing stimulation. It is understood that the spine illustrated in FIG. 5 is partial, and not all vertebrae are shown. In FIG. 6, the user interface on the clinician programmer displays a text box indicating that the correlation of pain map and dermatome map is complete, and the recommendations for stimulation are as follows: lead type=>2×6 paddle; lead location=>C5-T1 (fifth cervical vertebra through the first thoracic vertebra). Note that C5-T1 correspond to the highlighted regions of the spine shown in FIG. 5. In addition, it is understood that in some other embodiments, there may be several distinct recommended implant locations in response to the correlation between the pain map and the dermatome map. For example, the recommended implant locations may include C3-C5 as a first recommended implant location and L1-L3 as a second recommended implant location. These two recommended implant locations may not be covered by a single lead, and thus two or more leads may be implanted to effectively treat the patient's pain.

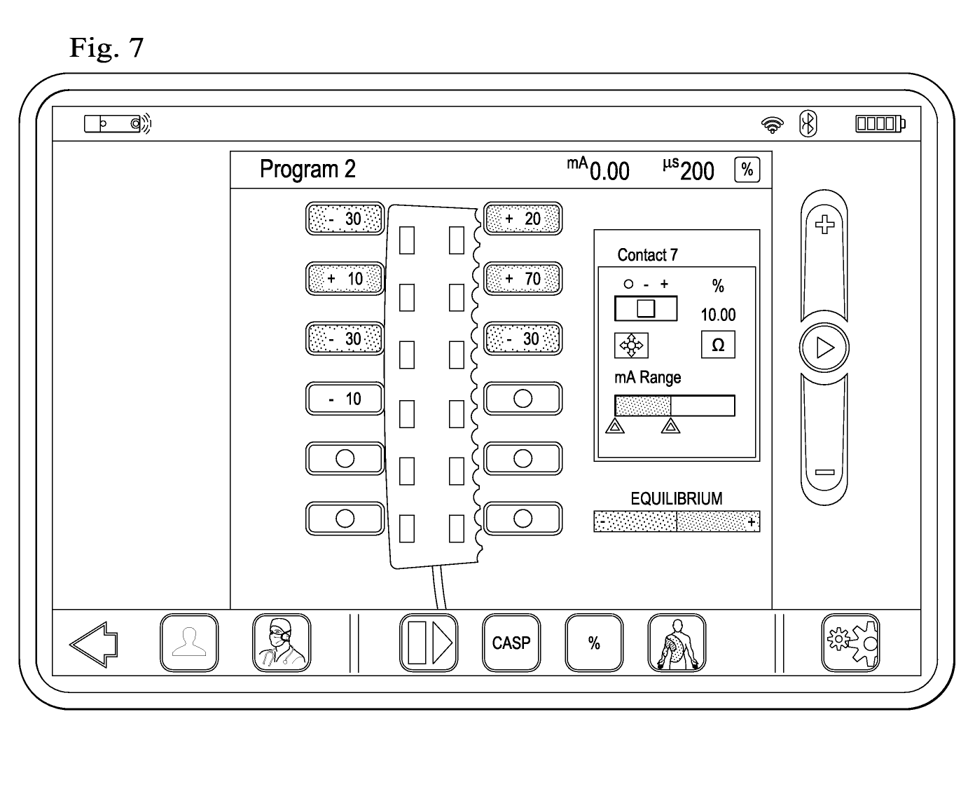

The user (e.g., the healthcare professional) may dismiss the recommendation, modify it, or accept it (by pressing next). If the user accepts or modifies the lead implant location and/or lead type, the clinician programmer may suggest stimulation parameters. For example, referring now to FIG. 7, the user interface on the clinician programmer may bring up a programming screen with the recommended stimulation parameters already applied, which may include (but are not limited to) anode/cathode configuration on the lead, stimulation current distribution percentages, stimulation current amplitude, pulse width, etc. Additional programming options are discussed in U.S. patent application Ser. No. 13/601,631, filed on Aug. 31, 2012, entitled “Programming and Virtual Reality Representation of Stimulation Parameter Groups”, attorney docket number 46901.27/QIG 099, the disclosure of which is hereby incorporated by reference in its entirety. The user may then modify one or more of these stimulation parameters as he deems appropriate.

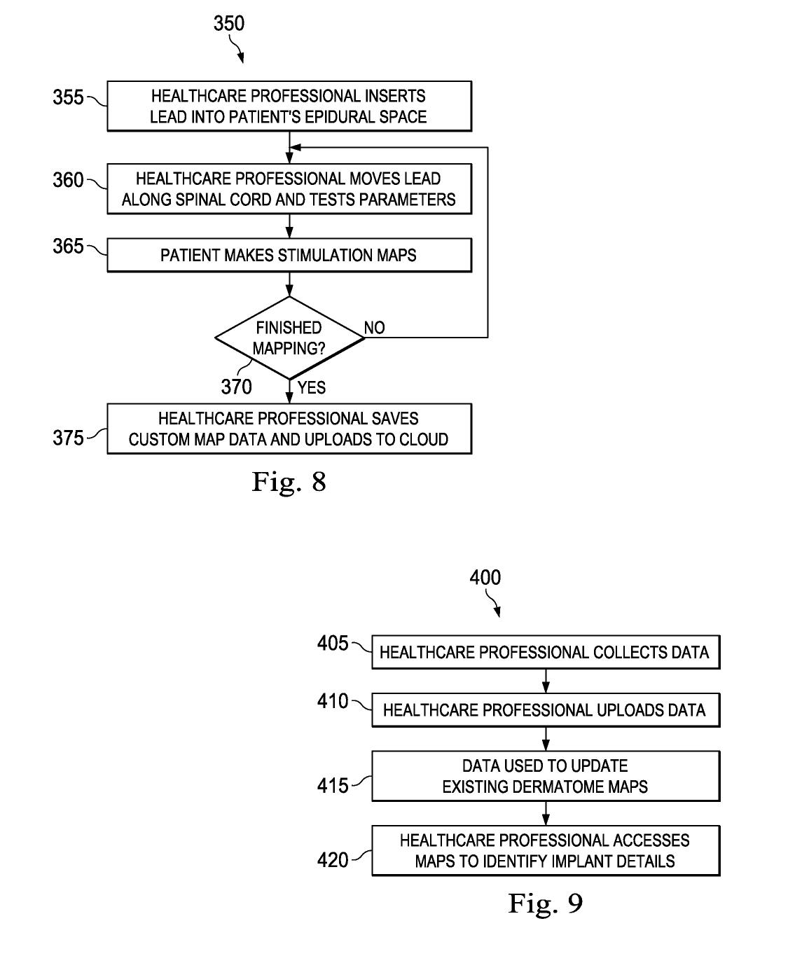

FIGS. 8-14 are simplified flowcharts describing the various processes discussed above with respect to providing and using a dermatome map to automatically provide a recommendation for implanting a neurostimulator.

FIG. 8 is a simplified flowchart of a method 350 for providing a customized dermatome map according to some embodiments of the present disclosure. The method 350 includes a step 355, in which a healthcare professional inserts a lead into a target patient's epidural space. The method 350 continues with step 360 in which the healthcare professional moves the lead along the spinal cord of the patient and tests various stimulation parameters. The method 350 includes a step 365 in which the patient makes stimulation maps in response to the stimulation delivered in step 360. The method 350 then proceeds to a decision step 370 to determine whether the mapping is finished. If the answer is no, then the method 350 loops back to step 360 again. If the answer is yes, then the method 350 proceeds to step 375, in which the healthcare professional saves custom map data and uploads to the cloud (e.g., the remote electronic database discussed above).

FIG. 9 is a simplified flowchart of a method 400 for updating and using a database used to store dermatome maps. The dermatome maps may include preloaded dermatome maps, a library of dermatome maps, or custom-created dermatome maps. The dermatome map database can be used to update the clinician programmer, and the clinician programmer's user can upload new dermatome maps or other information to the database as well. As FIG. 9 shows, the method 400 includes a step 405, in which a healthcare professional collects data. These data include custom dermatome maps, pain and stimulation maps, and patient specifics such as weight, height, age, gender, ethnicity, and medical conditions of the patient. The method 400 continues to a step 410, in which the healthcare professional uploads these data to the database. The method 400 continues to a step 415, in which the uploaded data is used to update existing dermatome map data already in the database. The method 400 continues to a step 420, in which the healthcare professional accesses the maps to identify implant details. For example, the dermatome map data may be used to suggest details of the implant such as lead type and location as well as stimulation parameters.

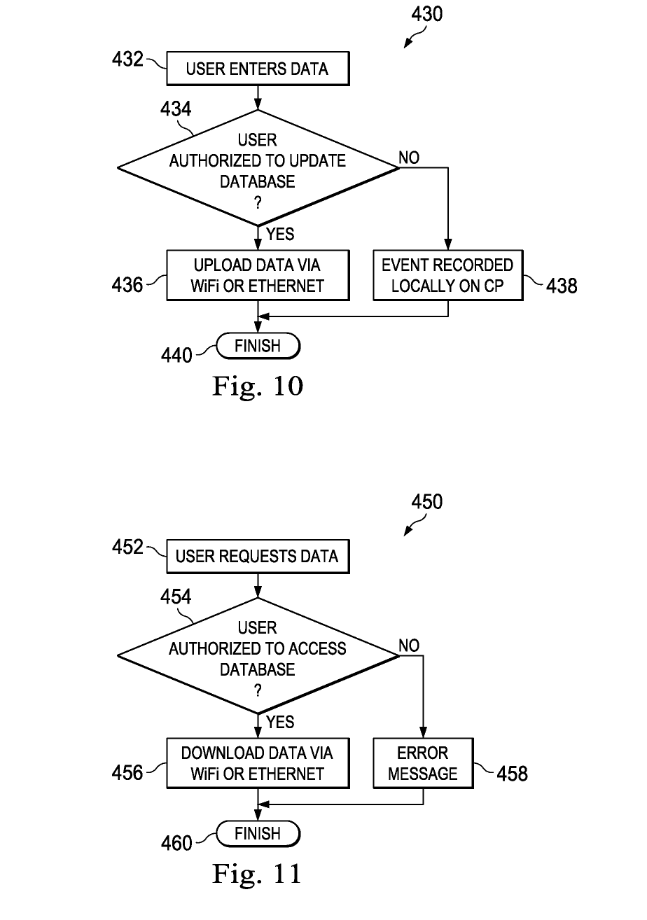

FIG. 10 is a simplified flowchart of a method 430 that describes an example process flow for uploading a dermatome map or a pain/stimulation map to a database. The method 430 includes a step 432, in which a user attempts to enter data into the database. The data may include the dermatome map or a pain/stimulation map, for example. The method 430 continues with a decision step 434 to determine whether the user is authorized to update the database. If the answer is yes, then the data is allowed to be uploaded to the database, for example via a Wi-Fi or Ethernet network. On the other hand, if the user does not have the right to access or update the database, the method 430 proceeds to step 438, in which the event (i.e., the attempt by the user to upload the data to the database) is recorded locally on the electronic programmer. In this case, the dermatome map or pain/stimulation map may be saved locally on the electronic programmer. The method 430 concludes with step 440.

FIG. 11 is a simplified flowchart of a method 450 that describes an example process flow for downloading a dermatome map or a pain/stimulation map from a database. The method 450 includes a step 452, in which a user attempts to request data to be downloaded from a database, for example the database discussed above with reference to FIG. 10, in which the data was uploaded. The data may include the dermatome map or a pain/stimulation map, for example. The method 450 continues with a decision step 454 to determine whether the user is authorized to access the database. If the answer is yes, then the data is allowed to be downloaded to a local device such as a clinician programmer. The downloading may take place via a Wi-Fi or Ethernet network, or via another suitable telecommunications network. On the other hand, if the user does not have the right to access the database, the method 450 proceeds to step 458, in which an error message may be displayed. The method 450 concludes with step 460.

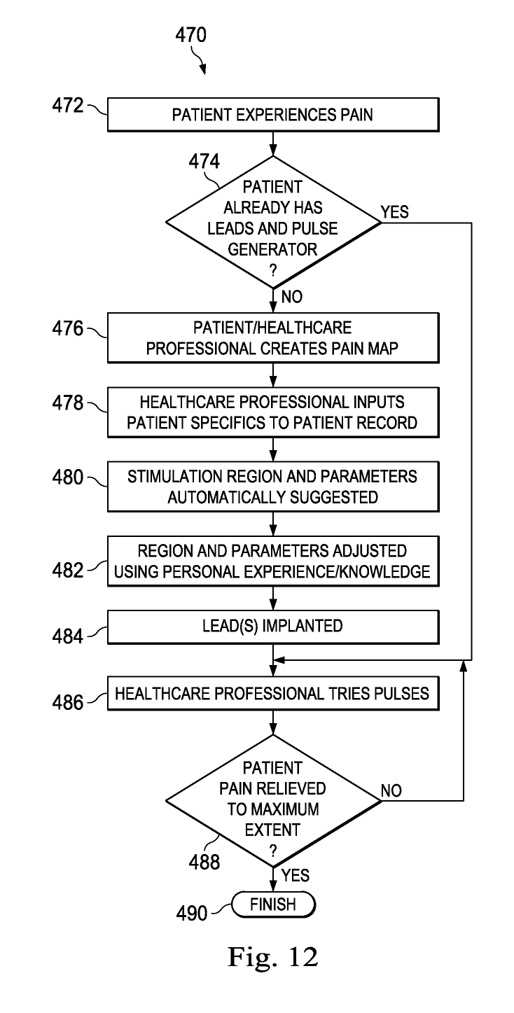

FIG. 12 is a simplified flowchart of a method 470 of automatically determining a suggested implant region and stimulation parameters according to various aspects of the present disclosure. The method 470 includes a step 472, in which the patient experiences pain. The method 470 includes a decision step 474 to determine whether the patient already had leads and pulse generators. If the answer is no, the method 470 continues with a step 476, in which the healthcare professional creates a pain map. The method 470 then continues with a step 478, in which the healthcare professional inputs patient specifics to the patient record. The method 470 then continues with a step 480, in which the implant region (also referred to as stimulation region) and stimulation parameters are automatically suggested. The method 470 then continues with a step 482, in which the implant region and the stimulation parameters are adjusted using the healthcare professional's personal experience and knowledge. The method 470 then continues with a step 484, in which the leads are implanted. The method 470 then continues with a step 486, in which the healthcare professional tries stimulation pulses.

If the answer from the decision step 474 is no, the method 470 proceeds directly to the step 486. After the step 486, the method 470 continues with a decision step 488 to determine whether the patient's pain is relieved to the maximum extent. If the answer is yes, then the method 470 finishes at step 490. If the answer is no, the method 470 loops back to the step 486 again. It is understood that additional steps may be performed before, during, or after the various steps of the method 470 discussed above, but they are not specifically illustrated herein for reasons of simplicity.

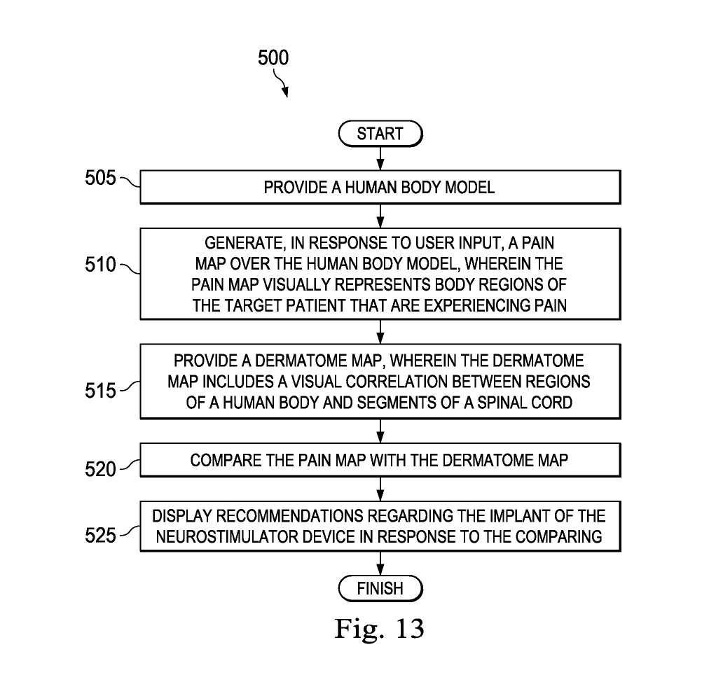

FIG. 13 is a simplified flowchart of a method 500 of determining stimulation lead placements for a healthcare professional with respect to an implant of a neurostimulator device in a target patient. The method 500 includes a step 505, in which a human body model is provided.

In some embodiments, the step 505 includes selecting the human body model from a database of human body models having varying physiological characteristics. The selecting is performed such that the selected human body model has a closest match to the target patient's physiological characteristics.

The method 500 includes a step 510, in which a pain map is generated over the human body model in response to user input. The pain map visually represents body regions of the target patient that are experiencing pain. In some embodiments, step 510 includes generating a three-dimensional (3D) pain map.

The method 500 includes a step 515, in which a dermatome map is provided. The dermatome map includes a visual correlation between regions of a human body and segments of a spinal cord. In some embodiments, the step 515 includes providing a three-dimensional (3D) dermatome map. In some embodiments, the step 515 includes generating a customized dermatome map. The customized dermatome may be uploaded to a database. The uploading may be performed so that physiological characteristics of the target patient are retained while biographical identification information of the target patient is removed before the uploading.

In some embodiments, the generation of the customized dermatome map includes, generating, in response to user input, a plurality of stimulation maps as different segments of the spinal cords undergo stimulation. The stimulation maps visually represent body regions of the target patient experiencing stimulation. Each stimulation map corresponds to the stimulation of a respective segment of the spinal cord. In some embodiments, the step of generating the customized dermatome map includes selecting the dermatome map from a database of dermatome maps that correspond to pre-existing patients with different physiological characteristics. In some embodiments, the selecting is performed such that the selected dermatome map is associated with one or more pre-existing patients in the database who have at least one matching physiological characteristic with the target patient. In other embodiments, the selecting is performed such that the selected dermatome map is associated with one or more pre-existing patients who were previously treated by the healthcare professional.

The method 500 includes a step 520, in which the pain map is compared with the dermatome map.

The method 500 includes a step 525, in which recommendations are displayed regarding the implant of the neurostimulator device in response to the comparing. In some embodiments, the step 525 is performed so that the recommendations displayed are with respect to at least one of: one or more target implant locations, an implant lead type, and stimulation parameters.

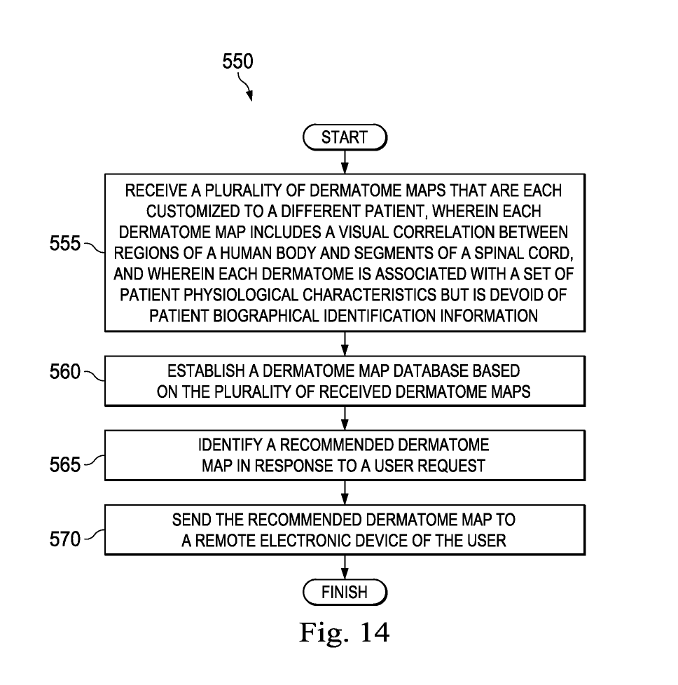

FIG. 14 is a simplified flowchart of a method 550 of providing a recommended dermatome map for a healthcare professional to facilitate an implant of a neurostimulator device in a target patient. The method 550 includes a step 555, in which a plurality of dermatome maps is received. The dermatome maps are each customized to a different patient. Each dermatome map includes a visual correlation between regions of a human body and segments of a spinal cord, and wherein each dermatome is associated with a set of patient physiological characteristics but is devoid of patient biographical identification information.

The method 550 includes a step 560, in which a dermatome map database is established based on the plurality of received dermatome maps. At least a subset of the dermatome maps in the dermatome database is in a three-dimensional (3D) form. In some embodiments, the dermatome maps are each generated based on a plurality of stimulation maps. In some embodiments, the dermatome maps are received from one or more portable electronic devices. For each dermatome map, the physiological characteristics of its corresponding patient are retained while biographical identification information of the corresponding patient is removed.

The method 550 includes a step 565, in which a recommended dermatome map is identified in response to a user request. In some embodiments, the step 565 includes a step of selecting, from the dermatome map database, a dermatome map whose associated patient physiological characteristics most closely matches physiological characteristics of the target patient. In some other embodiments, the step 565 includes a step of selecting, from the dermatome map database, a dermatome map whose associated patient had been previously treated by the healthcare professional. In yet some other embodiments, the step 565 includes a step of generating the recommended dermatome map by averaging a subset of dermatome maps that each have at least one matching patient physiological characteristic with the target patient.

The method 550 includes a step 570, in which the recommended dermatome map is sent to a remote electronic device of the user.

The method 550 may include an additional step of: providing, in response to user request, a human body model whose physiological characteristics match physiological characteristics of the target patient. The human body model is provided in a three-dimensional (3D) form.

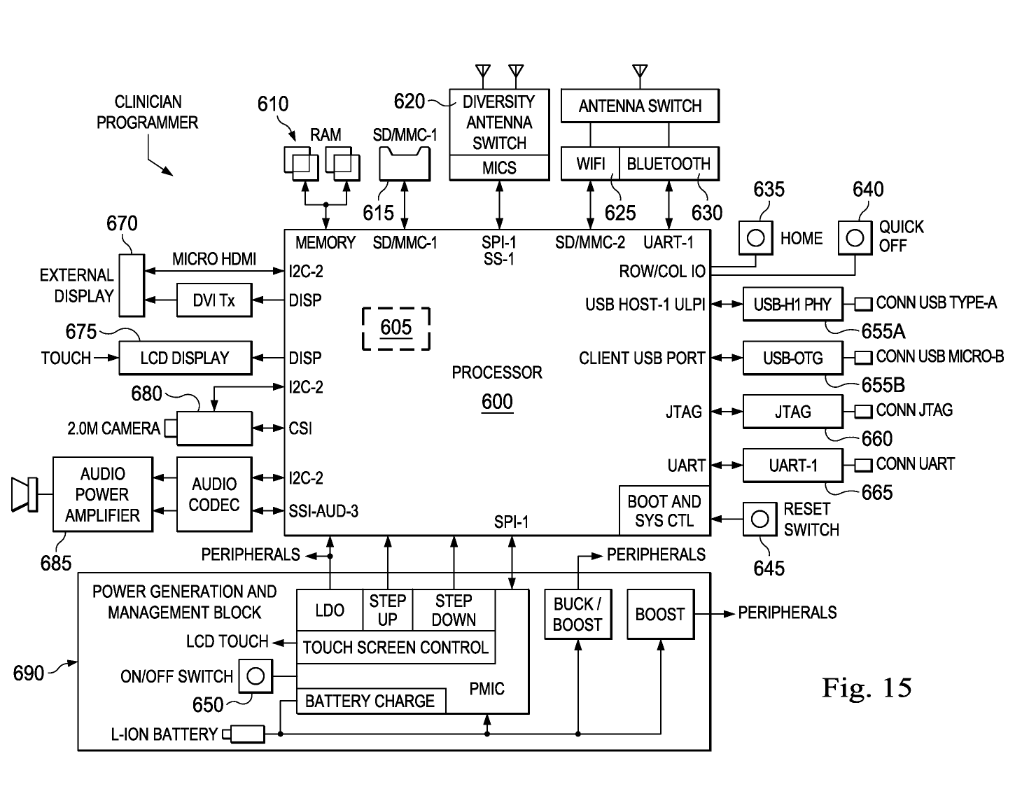

FIG. 15 shows a block diagram of one embodiment of the electronic programmer (CP) discussed herein. For example, the electronic programmer may be a clinician programmer (CP) configured to generate and display the 3D and 2D sensation maps and the dermatome maps discussed above. It is understood, however, that alternative embodiments of the electronic programmer may be used to perform these representations as well.

The CP includes a printed circuit board (“PCB”) that is populated with a plurality of electrical and electronic components that provide power, operational control, and protection to the CP. With reference to FIG. 15, the CP includes a processor 600. The processor 600 controls the CP. In one construction, the processor 600 is an applications processor model i.MX515 available from Free scale Semiconductor®. More specifically, the i.MX515 applications processor has internal instruction and data caches, multimedia capabilities, external memory interfacing, and interfacing flexibility. Further information regarding the i.MX515 applications processor can be found in, for example, the “IMX510EC, Rev. 4” data sheet dated August 2010 and published by Free scale Semiconductor® at www.freescale.com. The content of the data sheet is incorporated herein by reference. Of course, other processing units, such as other microprocessors, microcontrollers, digital signal processors, etc., can be used in place of the processor 600.

The CP includes memory, which can be internal to the processor 600 (e.g., memory 605), external to the processor 600 (e.g., memory 610), or a combination of both. Exemplary memory include a read-only memory (“ROM”), a random access memory (“RAM”), an electrically erasable programmable read-only memory (“EEPROM”), a flash memory, a hard disk, or another suitable magnetic, optical, physical, or electronic memory device. The processor 600 executes software that is capable of being stored in the RAM (e.g., during execution), the ROM (e.g., on a generally permanent basis), or another non-transitory computer readable medium such as another memory or a disc. The CP also includes input/output (“I/O”) systems that include routines for transferring information between components within the processor 600 and other components of the CP or external to the CP.

Software included in the implementation of the CP is stored in the memory 605 of the processor 600, RAM 610, ROM 615, or external to the CP. The software includes, for example, firmware, one or more applications, program data, one or more program modules, and other executable instructions. The processor 600 is configured to retrieve from memory and execute, among other things, instructions related to the control processes and methods described below for the CP.

One memory shown in FIG. 15 is memory 610, which may be a double data rate (DDR2) synchronous dynamic random access memory (SDRAM) for storing data relating to and captured during the operation of the CP. In addition, a secure digital (SD) multimedia card (MMC) may be coupled to the CP for transferring data from the CP to the memory card via slot 615. Of course, other types of data storage devices may be used in place of the data storage devices shown in FIG. 15.

The CP includes multiple bi-directional radio communication capabilities. Specific wireless portions included with the CP are a Medical Implant Communication Service (MICS) bi-directional radio communication portion 620, a Wi-Fi bi-directional radio communication portion 625, and a Bluetooth bi-directional radio communication portion 630. The MICS portion 620 includes a MICS communication interface, an antenna switch, and a related antenna, all of which allows wireless communication using the MICS specification. The Wi-Fi portion 625 and Bluetooth portion 630 include a Wi-Fi communication interface, a Bluetooth communication interface, an antenna switch, and a related antenna all of which allows wireless communication following the Wi-Fi Alliance standard and Bluetooth Special Interest Group standard. Of course, other wireless local area network (WLAN) standards and wireless personal area networks (WPAN) standards can be used with the CP.

The CP includes three hard buttons: a “home” button 635 for returning the CP to a home screen for the device, a “quick off” button 640 for quickly deactivating stimulation IPG, and a “reset” button 645 for rebooting the CP. The CP also includes an “ON/OFF” switch 650, which is part of the power generation and management block (discussed below).

The CP includes multiple communication portions for wired communication. Exemplary circuitry and ports for receiving a wired connector include a portion and related port for supporting universal serial bus (USB) connectivity 655, including a Type A port and a Micro-B port; a portion and related port for supporting Joint Test Action Group (JTAG) connectivity 660, and a portion and related port for supporting universal asynchronous receiver/transmitter (UART) connectivity 665. Of course, other wired communication standards and connectivity can be used with or in place of the types shown in FIG. 15.

Another device connectable to the CP, and therefore supported by the CP, is an external display. The connection to the external display can be made via a micro High-Definition Multimedia Interface (HDMI) 670, which provides a compact audio/video interface for transmitting uncompressed digital data to the external display. The use of the HDMI connection 670 allows the CP to transmit video (and audio) communication to an external display. This may be beneficial in situations where others (e.g., the surgeon) may want to view the information being viewed by the healthcare professional. The surgeon typically has no visual access to the CP in the operating room unless an external screen is provided. The HDMI connection 670 allows the surgeon to view information from the CP, thereby allowing greater communication between the clinician and the surgeon. For a specific example, the HDMI connection 670 can broadcast a high definition television signal that allows the surgeon to view the same information that is shown on the LCD (discussed below) of the CP.

The CP includes a touch screen I/O device 675 for providing a user interface with the clinician. The touch screen display 675 can be a liquid crystal display (LCD) having a resistive, capacitive, or similar touch-screen technology. It is envisioned that multitouch capabilities can be used with the touch screen display 675 depending on the type of technology used.

The CP includes a camera 680 allowing the device to take pictures or video. The resulting image files can be used to document a procedure or an aspect of the procedure. Other devices can be coupled to the CP to provide further information, such as scanners or RFID detection. Similarly, the CP includes an audio portion 685 having an audio codec circuit, audio power amplifier, and related speaker for providing audio communication to the user, such as the clinician or the surgeon.

The CP further includes a power generation and management block 690. The power block 690 has a power source (e.g., a lithium-ion battery) and a power supply for providing multiple power voltages to the processor, LCD touch screen, and peripherals.

In one embodiment, the CP is a handheld computing tablet with touch screen capabilities. The tablet is a portable personal computer with a touch screen, which is typically the primary input device. However, an external keyboard or mouse can be attached to the CP. The tablet allows for mobile functionality not associated with even typical laptop personal computers. The hardware may include a Graphical Processing Unit (GPU) in order to speed up the user experience. An Ethernet port (not shown in FIG. 15) may also be included for data transfer.

It is understood that a patient programmer may be implemented in a similar manner as the clinician programmer shown in FIG. 15.

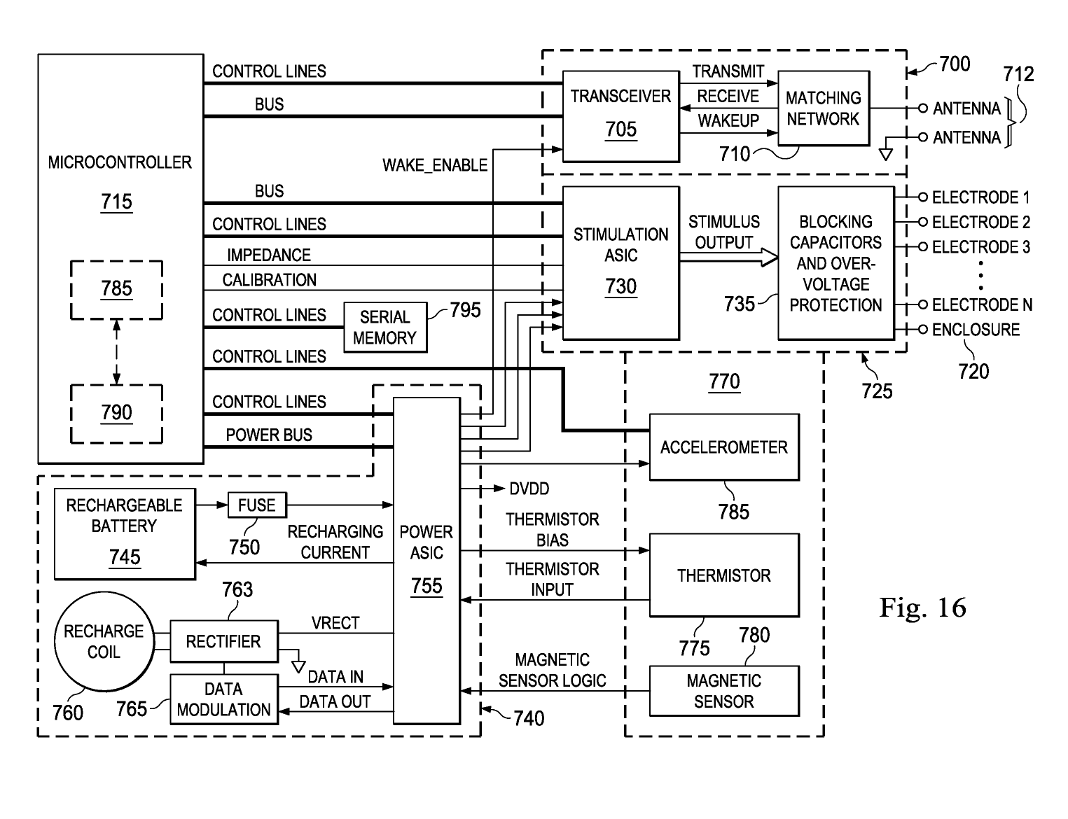

FIG. 16 shows a block diagram of one embodiment of an implantable medical device. In the embodiment shown in FIG. 16, the implantable medical device includes an implantable pulse generator (IPG). The IPG includes a printed circuit board (“PCB”) that is populated with a plurality of electrical and electronic components that provide power, operational control, and protection to the IPG. With reference to FIG. 16, the IPG includes a communication portion 700 having a transceiver 705, a matching network 710, and antenna 712. The communication portion 700 receives power from a power ASIC (discussed below), and communicates information to/from the microcontroller 715 and a device (e.g., the CP) external to the IPG. For example, the IPG can provide bi-direction radio communication capabilities, including Medical Implant Communication Service (MICS) bi-direction radio communication following the MICS specification.

The IPG provides stimuli to electrodes of an implanted medical electrical lead (not illustrated herein). As shown in FIG. 16, N electrodes are connected to the IPG. In addition, the enclosure or housing 720 of the IPG can act as an electrode. The stimuli are provided by a stimulation portion 225 in response to commands from the microcontroller 215. The stimulation portion 725 includes a stimulation application specific integrated circuit (ASIC) 730 and circuitry including blocking capacitors and an over-voltage protection circuit. As is well known, an ASIC is an integrated circuit customized for a particular use, rather than for general purpose use. ASICs often include processors, memory blocks including ROM, RAM, EEPROM, FLASH, etc. The stimulation ASIC 730 can include a processor, memory, and firmware for storing preset pulses and protocols that can be selected via the microcontroller 715. The providing of the pulses to the electrodes is controlled through the use of a waveform generator and amplitude multiplier of the stimulation ASIC 730, and the blocking capacitors and overvoltage protection circuitry 735 of the stimulation portion 725, as is known in the art. The stimulation portion 725 of the IPG receives power from the power ASIC (discussed below). The stimulation ASIC 730 also provides signals to the microcontroller 715. More specifically, the stimulation ASIC 730 can provide impedance values for the channels associated with the electrodes, and also communicate calibration information with the microcontroller 715 during calibration of the IPG.

The IPG also includes a power supply portion 740. The power supply portion includes a rechargeable battery 745, fuse 750, power ASIC 755, recharge coil 760, rectifier 763 and data modulation circuit 765. The rechargeable battery 745 provides a power source for the power supply portion 740. The recharge coil 760 receives a wireless signal from the PPC. The wireless signal includes an energy that is converted and conditioned to a power signal by the rectifier 763. The power signal is provided to the rechargeable battery 745 via the power ASIC 755. The power ASIC 755 manages the power for the IPG. The power ASIC 755 provides one or more voltages to the other electrical and electronic circuits of the IPG. The data modulation circuit 765 controls the charging process.

The IPG also includes a magnetic sensor 780. The magnetic sensor 780 provides a “hard” switch upon sensing a magnet for a defined period. The signal from the magnetic sensor 780 can provide an override for the IPG if a fault is occurring with the IPG and is not responding to other controllers.

The IPG is shown in FIG. 16 as having a microcontroller 715. Generally speaking, the microcontroller 715 is a controller for controlling the IPG. The microcontroller 715 includes a suitable programmable portion 785 (e.g., a microprocessor or a digital signal processor), a memory 790, and a bus or other communication lines. An exemplary microcontroller capable of being used with the IPG is a model MSP430 ultra-low power, mixed signal processor by Texas Instruments. More specifically, the MSP430 mixed signal processor has internal RAM and flash memories, an internal clock, and peripheral interface capabilities. Further information regarding the MSP 430 mixed signal processor can be found in, for example, the “MSP430G2x32, MSP430G2x02 MIXED SIGNAL MICROCONTROLLER” data sheet; dated December 2010, published by Texas Instruments at www.ti.com; the content of the data sheet being incorporated herein by reference.

The IPG includes memory, which can be internal to the control device (such as memory 790), external to the control device (such as serial memory 795), or a combination of both. Exemplary memory include a read-only memory (“ROM”), a random access memory (“RAM”), an electrically erasable programmable read-only memory (“EEPROM”), a flash memory, a hard disk, or another suitable magnetic, optical, physical, or electronic memory device. The programmable portion 785 executes software that is capable of being stored in the RAM (e.g., during execution), the ROM (e.g., on a generally permanent basis), or another non-transitory computer readable medium such as another memory or a disc.

Software included in the implementation of the IPG is stored in the memory 790. The software includes, for example, firmware, one or more applications, program data, one or more program modules, and other executable instructions. The programmable portion 785 is configured to retrieve from memory and execute, among other things, instructions related to the control processes and methods described below for the IPG. For example, the programmable portion 285 is configured to execute instructions retrieved from the memory 790 for sweeping the electrodes in response to a signal from the CP.

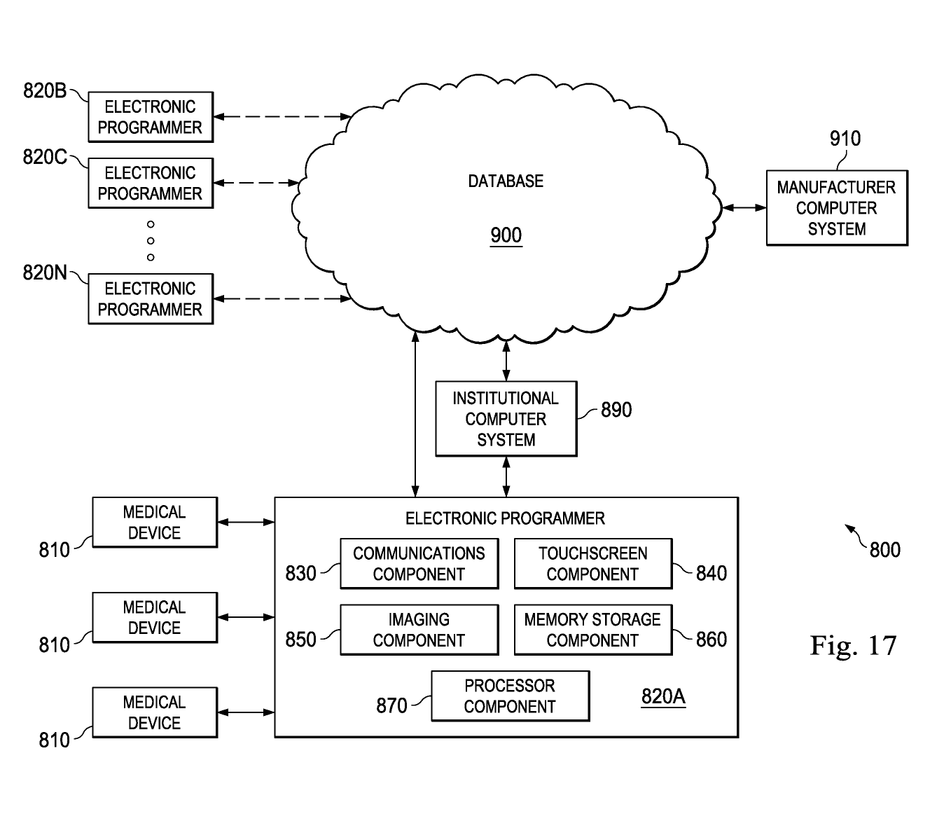

Referring now to FIG. 17, a simplified block diagram of a medical infrastructure 800 (which may also be considered a medical system) is illustrated according to various aspects of the present disclosure. The medical infrastructure 800 includes a plurality of medical devices 810. These medical devices 810 may each be a programmable medical device (or parts thereof) that can deliver a medical therapy to a patient. In some embodiments, the medical devices 810 may include a device of the neurostimulator system discussed above with reference to FIG. 1. For example, the medical devices 810 may be a pulse generator (e.g., the IPG discussed above with reference to FIG. 16), an implantable lead, a charger, or portions thereof. It is understood that each of the medical devices 810 may be a different type of medical device. In other words, the medical devices 810 need not be the same type of medical device.

The medical infrastructure 800 also includes a plurality of electronic programmers 820. For sake of illustration, one of these electronic programmers 820A is illustrated in more detail and discussed in detail below. Nevertheless, it is understood that each of the electronic programmers 820 may be implemented similar to the electronic programmer 820A.

In some embodiments, the electronic programmer 820A may be a clinician programmer, for example the clinician programmer discussed above with reference to FIG. 15. In other embodiments, the electronic programmer 820A may be a patient programmer or another similar programmer. In further embodiments, it is understood that the electronic programmer may be a tablet computer. In any case, the electronic programmer 820A is configured to program the stimulation parameters of the medical devices 810 so that a desired medical therapy can be delivered to a patient.

The electronic programmer 820A contains a communications component 830 that is configured to conduct electronic communications with external devices. For example, the communications device 830 may include a transceiver. The transceiver contains various electronic circuitry components configured to conduct telecommunications with one or more external devices. The electronic circuitry components allow the transceiver to conduct telecommunications in one or more of the wired or wireless telecommunications protocols, including communications protocols such as IEEE 802.11 (Wi-Fi), IEEE 802.15 (Bluetooth), GSM, CDMA, LTE, WIMAX, DLNA, HDMI, Medical Implant Communication Service (MICS), etc. In some embodiments, the transceiver includes antennas, filters, switches, various kinds of amplifiers such as low-noise amplifiers or power amplifiers, digital-to-analog (DAC) converters, analog-to-digital (ADC) converters, mixers, multiplexers and demultiplexers, oscillators, and/or phase-locked loops (PLLs). Some of these electronic circuitry components may be integrated into a single discrete device or an integrated circuit (IC) chip.

The electronic programmer 820A contains a touchscreen component 840. The touchscreen component 840 may display a touch-sensitive graphical user interface that is responsive to gesture-based user interactions. The touch-sensitive graphical user interface may detect a touch or a movement of a user's finger(s) on the touchscreen and interpret these user actions accordingly to perform appropriate tasks. The graphical user interface may also utilize a virtual keyboard to receive user input. In some embodiments, the touch-sensitive screen may be a capacitive touchscreen. In other embodiments, the touch-sensitive screen may be a resistive touchscreen.

It is understood that the electronic programmer 820A may optionally include additional user input/output components that work in conjunction with the touchscreen component 840 to carry out communications with a user. For example, these additional user input/output components may include physical and/or virtual buttons (such as power and volume buttons) on or off the touch-sensitive screen, physical and/or virtual keyboards, mouse, track balls, speakers, microphones, light-sensors, light-emitting diodes (LEDs), communications ports (such as USB or HDMI ports), joy-sticks, etc.

The electronic programmer 820A contains an imaging component 850. The imaging component 850 is configured to capture an image of a target device via a scan. For example, the imaging component 850 may be a camera in some embodiments. The camera may be integrated into the electronic programmer 820A. The camera can be used to take a picture of a medical device, or scan a visual code of the medical device, for example its barcode or Quick Response (QR) code.

The electronic programmer contains a memory storage component 860. The memory storage component 860 may include system memory, (e.g., RAM), static storage 608 (e.g., ROM), or a disk drive (e.g., magnetic or optical), or any other suitable types of computer readable storage media. For example, some common types of computer readable media may include floppy disk, flexible disk, hard disk, magnetic tape, any other magnetic medium, CD-ROM, any other optical medium, RAM, PROM, EPROM, FLASH-EPROM, any other memory chip or cartridge, or any other medium from which a computer is adapted to read. The computer readable medium may include, but is not limited to, non-volatile media and volatile media. The computer readable medium is tangible, concrete, and non-transitory. Logic (for example in the form of computer software code or computer instructions) may be encoded in such computer readable medium. In some embodiments, the memory storage component 860 (or a portion thereof) may be configured as a local database capable of storing electronic records of medical devices and/or their associated patients.

The electronic programmer contains a processor component 870. The processor component 870 may include a central processing unit (CPU), a graphics processing unit (GPU) a micro-controller, a digital signal processor (DSP), or another suitable electronic processor capable of handling and executing instructions. In various embodiments, the processor component 870 may be implemented using various digital circuit blocks (including logic gates such as AND, OR, NAND, NOR, XOR gates, etc.) along with certain software code. In some embodiments, the processor component 870 may execute one or more sequences computer instructions contained in the memory storage component 860 to perform certain tasks.

It is understood that hard-wired circuitry may be used in place of (or in combination with) software instructions to implement various aspects of the present disclosure. Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

It is also understood that the electronic programmer 820A is not necessarily limited to the components 830-870 discussed above, but it may further include additional components that are used to carry out the programming tasks. These additional components are not discussed herein for reasons of simplicity. It is also understood that the medical infrastructure 800 may include a plurality of electronic programmers similar to the electronic programmer 820A discussed herein, but they are not illustrated in FIG. 17 for reasons of simplicity.

The medical infrastructure 800 also includes an institutional computer system 890. The institutional computer system 890 is coupled to the electronic programmer 820A. In some embodiments, the institutional computer system 890 is a computer system of a healthcare institution, for example a hospital. The institutional computer system 890 may include one or more computer servers and/or client terminals that may each include the necessary computer hardware and software for conducting electronic communications and performing programmed tasks. In various embodiments, the institutional computer system 890 may include communications devices (e.g., transceivers), user input/output devices, memory storage devices, and computer processor devices that may share similar properties with the various components 830-870 of the electronic programmer 820A discussed above. For example, the institutional computer system 890 may include computer servers that are capable of electronically communicating with the electronic programmer 820A through the MICS protocol or another suitable networking protocol.

The medical infrastructure 800 includes a database 900. In various embodiments, the database 900 is a remote database—that is, located remotely to the institutional computer system 890 and/or the electronic programmer 820A. The database 900 is electronically or communicatively (for example through the Internet) coupled to the institutional computer system 890 and/or the electronic programmer. In some embodiments, the database 900, the institutional computer system 890, and the electronic programmer 820A are parts of a cloud-based architecture. In that regard, the database 900 may include cloud-based resources such as mass storage computer servers with adequate memory resources to handle requests from a variety of clients. The institutional computer system 890 and the electronic programmer 820A (or their respective users) may both be considered clients of the database 900. In certain embodiments, the functionality between the cloud-based resources and its clients may be divided up in any appropriate manner. For example, the electronic programmer 820A may perform basic input/output interactions with a user, but a majority of the processing and caching may be performed by the cloud-based resources in the database 900. However, other divisions of responsibility are also possible in various embodiments.

According to the various aspects of the present disclosure, the sensation maps may be uploaded from the electronic programmer 820A to the database 900. The sensation maps saved in the database 900 may thereafter be downloaded by any of the other electronic programmers 820B-820N communicatively coupled to it, assuming the user of these programmers has the right login permissions. For example, after the 2D sensation map is generated by the electronic programmer 820A and uploaded to the database 900. That 2D sensation map can then be downloaded by the electronic programmer 820B, which can use the downloaded 2D sensation map to reconstruct or recreate a 3D sensation map. In this manner, a less data-intensive 2D sensation map may be derived from a data-heavy 3D sensation map, sent to a different programmer through the database, and then be used to reconstruct the 3D sensation map.

The database 900 may also include a manufacturer's database in some embodiments. It may be configured to manage an electronic medical device inventory, monitor manufacturing of medical devices, control shipping of medical devices, and communicate with existing or potential buyers (such as a healthcare institution). For example, communication with the buyer may include buying and usage history of medical devices and creation of purchase orders. A message can be automatically generated when a client (for example a hospital) is projected to run out of equipment, based on the medical device usage trend analysis done by the database. According to various aspects of the present disclosure, the database 900 is able to provide these functionalities at least in part via communication with the electronic programmer 820A and in response to the data sent by the electronic programmer 820A. These functionalities of the database 900 and its communications with the electronic programmer 820A will be discussed in greater detail later.

The medical infrastructure 800 further includes a manufacturer computer system 910. The manufacturer computer system 910 is also electronically or communicatively (for example through the Internet) coupled to the database 900. Hence, the manufacturer computer system 910 may also be considered a part of the cloud architecture. The computer system 910 is a computer system of medical device manufacturer, for example a manufacturer of the medical devices 810 and/or the electronic programmer 820A.

In various embodiments, the manufacturer computer system 910 may include one or more computer servers and/or client terminals that each includes the necessary computer hardware and software for conducting electronic communications and performing programmed tasks. In various embodiments, the manufacturer computer system 910 may include communications devices (e.g., transceivers), user input/output devices, memory storage devices, and computer processor devices that may share similar properties with the various components 830-870 of the electronic programmer 820A discussed above. Since both the manufacturer computer system 910 and the electronic programmer 820A are coupled to the database 900, the manufacturer computer system 910 and the electronic programmer 820A can conduct electronic communication with each other.

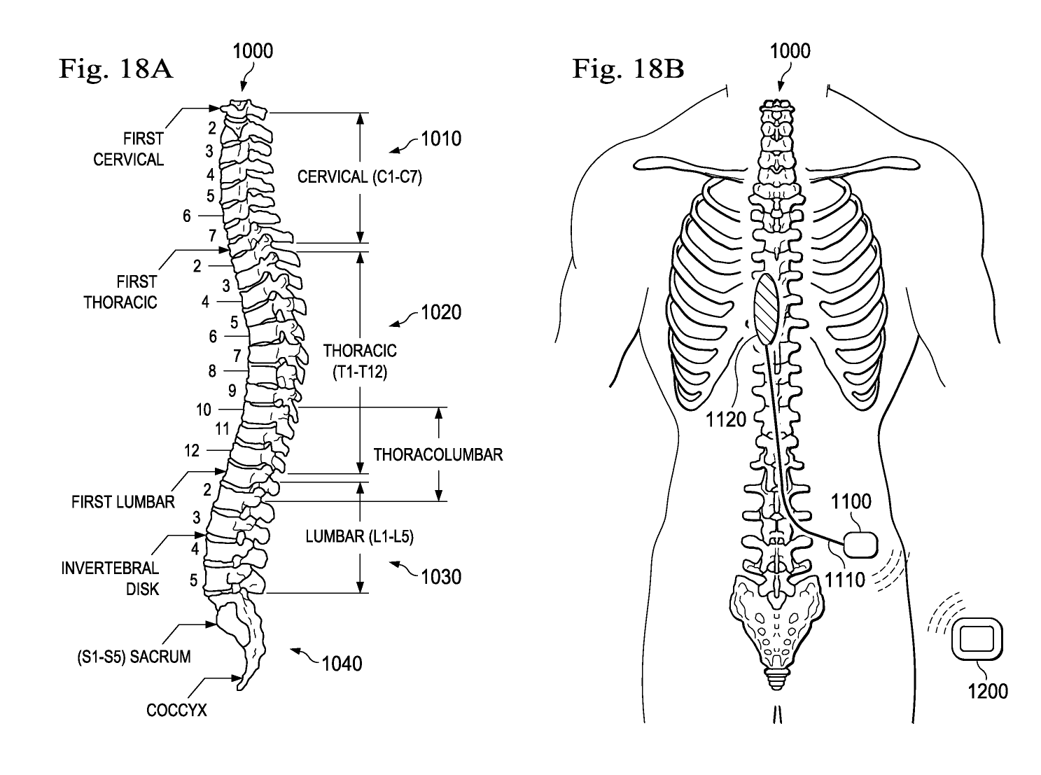

FIG. 18A is a side view of a spine 1000, and FIG. 18B is a posterior view of the spine 1000. The spine 1000 includes a cervical region 1010, a thoracic region 1020, a lumbar region 1030, and a sacrococcygeal region 1040. The cervical region 1010 includes the top 7 vertebrae, which may be designated with C1-C7. The thoracic region 1020 includes the next 12 vertebrae below the cervical region 1010, which may be designated with T1-T12. The lumbar region 1030 includes the final 5 “true” vertebrae, which may be designated with L1-L5. The sacrococcygeal region 1040 includes 9 fused vertebrae that make up the sacrum and the coccyx. The fused vertebrae of the sacrum may be designated with S1-S5.

Neural tissue (not illustrated for the sake of simplicity) branch off from the spinal cord through spaces between the vertebrae. The neural tissue can be individually and selectively stimulated in accordance with various aspects of the present disclosure. For example, referring to FIG. 18B, an IPG device 1100 is implanted inside the body. The IPG device 1100 may include a neurostimulator device. A conductive lead 1110 is electrically coupled to the circuitry inside the IPG device 1100. The conductive lead 1110 may be removably coupled to the IPG device 1100 through a connector, for example. A distal end of the conductive lead 1110 is attached to one or more electrodes 1120. The electrodes 1120 are implanted adjacent to a desired nerve tissue in the thoracic region 1020. Using well-established and known techniques in the art, the distal end of the lead 1110 with its accompanying electrodes may be positioned along or near the epidural space of the spinal cord. It is understood that although only one conductive lead 1110 is shown herein for the sake of simplicity, more than one conductive lead 1110 and corresponding electrodes 1120 may be implanted and connected to the IPG device 1100.

The electrodes 1120 deliver current drawn from the current sources in the IPG device 1100, therefore generating an electric field near the neural tissue. The electric field stimulates the neural tissue to accomplish its intended functions. For example, the neural stimulation may alleviate pain in an embodiment. In other embodiments, a stimulator may be placed in different locations throughout the body and may be programmed to address a variety of problems, including for example but without limitation; prevention or reduction of epileptic seizures, weight control or regulation of heart beats.

It is understood that the IPG device 1100, the lead 1110, and the electrodes 1120 may be implanted completely inside the body, may be positioned completely outside the body or may have only one or more components implanted within the body while other components remain outside the body. When they are implanted inside the body, the implant location may be adjusted (e.g., anywhere along the spine 1000) to deliver the intended therapeutic effects of spinal cord electrical stimulation in a desired region of the spine. Furthermore, it is understood that the IPG device 1100 may be controlled by a patient programmer or a clinician programmer 1200, the implementation of which may be similar to the clinician programmer shown in FIG. 15.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A system for determining stimulation lead placements for a healthcare professional with respect to an implant of a neurostimulator device in a target patient, the electronic device comprising:
a memory storage component configured to store programming code; and
a computer processor configured to execute the programming code to perform the following tasks:
providing a human body model;
generating, in response to user input, a pain map over the human body model, wherein the pain map visually represents body regions of the target patient that are experiencing pain;
providing a dermatome map, wherein the dermatome map includes a visual correlation between regions of a human body and segments of a spinal cord;
comparing the pain map with the dermatome map; and
displaying recommendations regarding the implant of the neurostimulator device in response to the comparing.

2. The system of claim 1, wherein the displaying recommendations comprises displaying recommendations with respect to at least one of: one or more target implant locations, an implant lead type, and stimulation parameters.

3. The system of claim 1, wherein the providing the human body model comprises selecting the human body model from a database of human body models having varying physiological characteristics, and wherein the selecting is performed such that the selected human body model has a closest match to the target patient's physiological characteristics.

4. The system of claim 1, wherein the generating the pain map comprises generating a three-dimensional (3D) pain map.

5. The system of claim 1, wherein the providing the dermatome map comprises providing a three-dimensional (3D) dermatome map.

6. The system of claim 1, wherein the providing the dermatome map comprises generating a customized dermatome map.

7. The system of claim 6, wherein the generating the customized dermatome map comprises generating, in response to user input, a plurality of stimulation maps as different segments of the spinal cords undergo stimulation, wherein the stimulation maps visually represent body regions of the target patient experiencing stimulation, and wherein each stimulation map corresponds to the stimulation of a respective segment of the spinal cord.

8. The system of claim 7, wherein the computer processor executes the programming code to further perform: uploading the customized dermatome to a database, wherein the uploading is performed so that physiological characteristics of the target patient are retained while biographical identification information of the target patient is removed before the uploading.

9. The system of claim 6, wherein the generating the customized dermatome map comprises selecting the dermatome map from a database of dermatome maps that correspond to pre-existing patients with different physiological characteristics.

10. The system of claim 9, wherein the selecting is performed such that the selected dermatome map is associated with one or more pre-existing patients in the database who have at least one matching physiological characteristic with the target patient.

11. The system of claim 9, wherein the selecting is performed such that the selected dermatome map is associated with one or more pre-existing patients who were previously treated by the healthcare professional.

12. The system of claim 1, wherein the memory storage component and the computer processor are implemented in a portable electronic programmer, and wherein the system further comprises a neurostimulator communicatively coupled with the portable electronic programmer, the neurostimulator being configured by the portable electronic programmer to deliver a medical therapy to the target patient.

13. The system of claim 12, further comprising a remote electronic database communicatively coupled to the portable electronic programmer, wherein the remote electronic database stores a plurality of downloadable dermatome maps.

14. A method of determining stimulation lead placements for a healthcare professional with respect to an implant of a neurostimulator device in a target patient, the method comprising:
providing a human body model;
generating, in response to user input, a pain map over the human body model, wherein the pain map visually represents body regions of the target patient that are experiencing pain;
providing a dermatome map, wherein the dermatome map includes a visual correlation between regions of a human body and segments of a spinal cord;
comparing the pain map with the dermatome map; and
displaying recommendations regarding the implant of the neurostimulator device in response to the comparing.

15. The method of claim 14, wherein the displaying recommendations comprises displaying recommendations with respect to at least one of: one or more target implant locations, an implant lead type, and stimulation parameters.

16. The method of claim 14, wherein the providing the human body model comprises selecting the human body model from a database of human body models having varying physiological characteristics, and wherein the selecting is performed such that the selected human body model has a closest match to the target patient's physiological characteristics.

17. The method of claim 14, wherein the generating the pain map comprises generating a three-dimensional (3D) pain map.

18. The method of claim 14, wherein the providing the dermatome map comprises providing a three-dimensional (3D) dermatome map.

19. The method of claim 14, wherein the providing the dermatome map comprises generating a customized dermatome map.

20. The method of claim 19, wherein the generating the customized dermatome map comprises generating, in response to user input, a plurality of stimulation maps as different segments of the spinal cords undergo stimulation, wherein the stimulation maps visually represent body regions of the target patient experiencing stimulation, and wherein each stimulation map corresponds to the stimulation of a respective segment of the spinal cord.

21. The method of claim 20, further comprising: uploading the customized dermatome to a database, wherein the uploading is performed so that physiological characteristics of the target patient are retained while biographical identification information of the target patient is removed before the uploading.

22. The method of claim 19, wherein the generating the customized dermatome map comprises selecting the dermatome map from a database of dermatome maps that correspond to pre-existing patients with different physiological characteristics.

23. The method of claim 22, wherein the selecting is performed such that the selected dermatome map is associated with one or more pre-existing patients in the database who have at least one matching physiological characteristic with the target patient.

24. The method of claim 22, wherein the selecting is performed such that the selected dermatome map is associated with one or more pre-existing patients who were previously treated by the healthcare professional.

25. A system of providing a recommended dermatome map for a healthcare professional to facilitate an implant of a neurostimulator device in a target patient, the system comprising:
an electronic server having a non-transitory computer readable medium comprising executable instructions that when executed by a processor, causes the processor to perform the steps of:
receiving a plurality of dermatome maps that are each customized to a different patient, wherein each dermatome map includes a visual correlation between regions of a human body and segments of a spinal cord, and wherein each dermatome is associated with a set of patient physiological characteristics but is devoid of patient biographical identification information;
establishing, on the electronic server, a dermatome map database based on the plurality of received dermatome maps;
identifying a recommended dermatome map in response to a user request; and
sending the recommended dermatome map to a remote electronic device of the user.

26. The system of claim 25, further comprising: one or more remote electronic programmers communicatively coupled to the electronic server, the electronic programmers being configured to generate the plurality of dermatome maps and send the dermatome maps to the electronic server.

27. The system of claim 26, further comprising: one or more neurostimulators communicatively coupled with the one or more remote electronic programmers, the one or more neurostimulators being configured by the one or more remote electronic programmers to deliver medical therapies to human patients.

28. The system of claim 26, wherein the electronic programmers are configured to send the dermatome maps to the electronic server in a manner such that, for each dermatome map, the physiological characteristics of its corresponding patient are retained while biographical identification information of the corresponding patient is removed.

29. The system of claim 25, wherein the identifying the recommended dermatome map comprises one of:
selecting, from the dermatome map database, a dermatome map whose associated patient physiological characteristics most closely match physiological characteristics of the target patient;
selecting, from the dermatome map database, a dermatome map whose associated patient had been previously treated by the healthcare professional; and
generating the recommended dermatome map by averaging a subset of dermatome maps that each have at least one matching patient physiological characteristic with the target patient.

30. The system of claim 25, wherein the dermatome maps are each generated based on a plurality of stimulation maps.

31. The system of claim 25, wherein the executable instructions cause the processor to further perform the step of: providing, in response to user request, a human body model whose physiological characteristics match physiological characteristics of the target patient.

32. The system of claim 31, wherein the human body model is provided in a three-dimensional (3D) form.

33. The system of claim 25, wherein at least a subset of the dermatome maps in the dermatome database is in a three-dimensional (3D) form.

34. A method of providing a recommended dermatome map for a healthcare professional to facilitate an implant of a neurostimulator device in a target patient, the method comprising:
receiving a plurality of dermatome maps that are each customized to a different patient, wherein each dermatome map includes a visual correlation between regions of a human body and segments of a spinal cord, and wherein each dermatome is associated with a set of patient physiological characteristics but is devoid of patient biographical identification information;
establishing a dermatome map database based on the plurality of received dermatome maps;
identifying a recommended dermatome map in response to a user request; and
sending the recommended dermatome map to a remote electronic device of the user.

35. The method of claim 34, wherein the identifying the recommended dermatome map comprises one of:
selecting, from the dermatome map database, a dermatome map whose associated patient physiological characteristics most closely match physiological characteristics of the target patient;
selecting, from the dermatome map database, a dermatome map whose associated patient had been previously treated by the healthcare professional; and
generating the recommended dermatome map by averaging a subset of dermatome maps that each have at least one matching patient physiological characteristic with the target patient.

36. The method of claim 34, wherein the dermatome maps are each generated based on a plurality of stimulation maps.

37. The method of claim 34, further comprising: providing, in response to user request, a human body model whose physiological characteristics match physiological characteristics of the target patient.

38. The method of claim 37, wherein the human body model is provided in a three-dimensional (3D) form.

39. The method of claim 34, wherein at least a subset of the dermatome maps in the dermatome database is in a three-dimensional (3D) form.

40. The method of claim 34, wherein the dermatome maps are received from one or more portable electronic devices, and wherein for each dermatome map, the physiological characteristics of its corresponding patient are retained while biographical identification information of the corresponding patient is removed.
